(19) United States
(12) Patent Application Publication
(10) Pub. No.: US 2006/0021666 A1
(43) Pub. Date: Feb. 2, 2006

(54) Microsystem, microopening film, and system and method for analizing interaction between biomolecules

(75) Inventors: Takashi Funatsu, Tokyo (JP); Shuichi Shoji, Tokyo (JP); Yasuo Wada, Tokyo (JP); Ken Tsutsui, Tokyo (JP); Jun Mizuno, Tokyo (JP); Yoshitaka Shirasaki, Tokyo (JP)

Correspondence Address: EDWARDS & ANGELL, LLP, P.O. BOX 55874, BOSTON, MA, 02205, US

(73) Assignee: Waseda University, Tokyo (JP)

(21) Appl. No.: 10/533,107

(22) PCT Filed: Oct. 30, 2003
(86) PCT No.: PCT/JP03/13902

§ 371 Date: Jul. 20, 2005

(30) Foreign Application Priority Data
Nov. 1, 2002 (JP) 2002-319577
Nov. 11, 2002 (JP) 2002-326217
Feb. 18, 2003 (JP) 2003-40330

(51) Int. Cl. G05D 7/06

(52) U.S. Cl. 137/828

(57) ABSTRACT

A micro system capable of setting an appropriate amount of stimulation being applied in order to control liquid flow in a channel. The micro system comprises micro-heaters (5b, 5c) for applying stimulation to liquid flowing through liquid channels (2b, 2c) formed in a plate (1) and controlling liquid flow by the stimulation from the micro-heaters (5b, 5c), and a means for electrically controlling the amount of stimulation being applied to the liquid from the micro-heaters (5b, 5c). An appropriate amount of stimulation can be set by electrically controlling the amount of stimulation being applied to the liquid from the micro-heaters (5b, 5c) through the control means.

### TECHNICAL FIELD

The invention relates to a micro-system for controlling liquid flow through a micro liquid channel, a nano-aperture film for detecting and quantifying biomolecular interaction at the level of a single molecule, and a device and method for analyzing biomolecular interaction.

### BACKGROUND ART

The progress of nano-technology in recent years has promoted the development of micro-systems for analyzing samples, or producing a reaction, by forming a liquid channel of micron order on chips such as glass, and passing a sample through this liquid channel. The micro-system has advantages such as the capability of analysis with small amounts of samples, which is attracting much attention.

However, in this micro-system, there are problems in that it is difficult to prepare a valve in a liquid channel for controlling the flow of the sample, and to control the flow of the sample.

In order to solve the problem in the conventional technique, Japanese Patent Publication No. 2002-163022 discloses a method for controlling the flow, comprising the steps of adding a sol-gel transitional substance transferred by the stimulation of heat such as from an external laser etc. to a liquid flowing in the minute liquid channel of the micro-system, and applying stimulation to a desired point on the minute liquid channel so as to transform the liquid into a gel. According to this method, without using a complicated valve structure, the liquid flow can be stopped, and the flow amount or the flow rate can be simply adjusted. When a branch is formed in a part of the channels and stimulation is applied to a liquid in a channel chosen from the branched channel, it is possible to choose a direction through which liquid flows by blocking the channel by turning the substance into a gel. By stopping stimulation, the substance turns into a sol and the channel is opened wide again.

According to the above-mentioned method, however, in the case where the appropriate amount of stimulation is not applied to the liquid, there is a problem in that it is not appropriately turned into the gel, and does not block the channel because the amount of stimulation is too little. There is also a problem in that the liquid is heated beyond necessity and it takes time for gelation, when the amount of stimulation is too much.

A first object of the present invention is to solve the above-mentioned problem, and to provide a micro-system which can apply an appropriate amount of stimulation in order to control a liquid flow in a channel.

Moreover, the above-mentioned method comprises: forming a liquid channel on a substrate in advance using conventional ultra-fine processing technology; and flowing a liquid through the formed liquid channel. As to the method of forming this liquid channel, there is, for example, a method of etching a substrate by a chemical reaction, and of cutting the substrate using a photocurable resin or a thermosetting resin. There is a problem in that this method needs complicated process for forming the liquid channel, and it takes time for this method. Moreover, in this method it is possible to stop the liquid flowing through the liquid channel and to adjust the flow amount by gelation, but only the existing liquid channel can be used and the liquid channel itself can not be newly formed or removed. Therefore it has a problem in that it is necessary to prepare the liquid channel with a different channel form for each purpose.

A second object of the present invention is to provide a matrix type variable liquid channel capable of forming and removing a liquid channel in arbitrary positions by freely forming a wall and a valve structure, and a system capable of controlling it. Also to provide a matrix type variable liquid channel which does not need a liquid channel to be formed on a plate in advance, and a system capable of controlling it.

On the other hand, as a conventional method for detecting and quantifying biomolecular interaction at the one molecule level, there are mainly the following two methods.

One is a method as shown in FIG. 35 for imaging a fluorescent biomolecule 306 using an evanescent field 305 generated at an interface 303 of a solution 302 by applying a laser light 304 to an interface 303 between a glass 301 and a solution 302 to induce total internal reflection. Since the evanescent field 305 is attenuated by the 150 nm penetration length from the interface 303, partial excitation is possible. When one fluorescent biomolecule 306 is fixed to the glass 301 and the other biomolecule labeled with a fluorescence molecule of another fluorescence wavelength is added to the solution 302, it is possible to take an image of an association and a dissociation of these biomolecules (interaction between molecules) by a high sensitivity camera 307. This single fluorescent molecule imaging method for biomolecules was developed by the inventors in 1995 (Funatsu, T. et al. (1995), Nature 374, 555-559), and has achieved various success. However, there are the following problems. 1. Unless concentration of the fluorescent biomolecule 306 in the solution 302 is less than 50 nM, it is difficult to observe one molecule. 2. Because fluorescent biomolecules nonspecifically bind to the glass 301, it is difficult to detect the interaction between molecules. Therefore, detecting biomolecular interaction at the one molecule level is limited.

The reason for these problems is as follows. The evanescent field induced by total internal reflection generates partial excitation 150 nm in the direction perpendicular to the interface 303, but it is not localized in the parallel direction. Therefore each fluorescent biomolecule 306 can not be imaged in the range of the resolution (about 250 nm) of the optical microscope connected to the high sensitivity camera 307 if the concentration of the fluorescent biomolecule 306 in the solution 302 is not set to less than 50 nM. Moreover, since the fluorescence 308 is affected by diffraction during transmission to the high sensitivity camera 307, the fluorescence 308 emitted by the fluorescent biomolecule 306 expands to a size which is equivalent to the diameter of about 250 nm in the surface of the sample. Therefore, in order to identify each fluorescent biomolecule 306, the interval of the fluorescent biomolecule 306 fixed to the glass 301 must be more than about 250 nm. Therefore, the rate of the area occupied by the fluorescent biomolecule 306 fixed on the glass 301 becomes as small as 0.1% or less, which results in a problem of nonspecific adsorption to the glass 301 of the biomolecule added into the solution 302. These problems are expected to be solved by making smaller domains where the fluorescent biomolecule 306 is excited, and arranging them at a position away from the resolution of the optical microscope connected to the high sensitivity camera 307.

The second method of detecting biomolecular interaction at the single molecule level is fluorescence correlation spectroscopy (FCS; Fluorescence Correlation Spectroscopy). As shown in FIG. 36, this is the method of obtaining the fluorescence intensity and diffusion constant of each fluorescent biomolecule 313, by narrowing down the laser beam 311 to the diffraction limit with a large numerical aperture object lens 312, and measuring the fluctuation of the fluorescence intensity of the fluorescent biomolecule 313 which passes through it (Eigen M. and Rigler, R. (1994) Proc. Natl. Acad. Sci. USA 91, 5740-5747, published Japanese translation of PCT International Publication No. H11-502608). In order to detect only the fluorescence 315 at the focus 314 of the laser beam 311, a confocal optical system with a pinhole on the image focus location of the laser beam 311 is used. If two kinds of fluorescence are correlated with each other, it is also possible to analyze two kinds of interaction between the fluorescent biomolecules 313. This method is called fluorescence Cross-correlation Spectroscopy (FCCS) (Rigker, R., Z. et al. (1998), Fluorescence cross-correlation-a new concept for polymerase chain reaction. J. Biotechnol. 63: 97-109). Also in this method, since the irradiation domain spreads to the extent of the diffraction limit of light, the concentration of the fluorescent biomolecule 313 can be raised only to about 100 nM. In order to observe the biomolecular interaction at higher concentration, partial excitation exceeding the diffraction limit of light is desired.

A third object of the present invention is to solve the above-mentioned problem, to realize making the irradiation domain of the excitation light smaller than the wavelength of the excitation light, and to provide a nano-aperture film to sensitively detect and determine biomolecular interaction at the level of a single molecule, and a device and method for analyzing biomolecular interaction.

### SUMMARY OF INVENTION

In a micro-system according to a first aspect of the invention, in order to achieve the first object, the present invention provides the micro-system comprising a stimulation applying means for applying stimulation to a liquid flowing in a liquid channel formed in a plate, the liquid flow being controlled by the stimulation from the stimulation applying means, wherein the stimulation applying means comprises a control means for electrically controlling an amount of stimulation applied to the liquid.

Thus, an appropriate amount of stimulation can be set by electrically controlling the amount of stimulation being applied to the liquid from the stimulation applying means by the control means.

According to a second aspect of the invention, the present invention provides the micro-system, further comprising a stimulation detecting means for detecting the amount of stimulation, wherein the stimulation applying means is a heat source or a light source, and said stimulation applying means is controlled by said control means based on a signal from said stimulation detecting means, in the above-mentioned first aspect of the invention.

Thus, an appropriate amount of stimulation can be set.

According to a third aspect of the invention, the present invention provides the micro-system, wherein the heat source is a micro-heater, in the above-mentioned second aspect of the invention.

Thus, the stimulation can be certainly applied to the liquid.

According to a fourth aspect of the invention, the present invention provides the micro-system, wherein said stimulation detecting means is a heat sensor provided on the liquid channel, in the above-mentioned second aspect of the invention.

Thus, the amount of stimulation being applied to the liquid from the stimulation applying means can be certainly detected.

According to a fifth aspect of the invention, the present invention provides the micro-system, wherein the heat sensor is a thermo-couple, in the above-mentioned fourth aspect of the invention.

Thus, the heat sensor can be constituted easily.

According to a sixth aspect of the invention, the present invention provides the micro-system, wherein the heat sensor is a heat sensitive semiconductor or an infrared ray sensitive sensor, in the above-mentioned fourth aspect of the invention.

Thus, the amount of stimulation is certainly detectable.

According to a seventh aspect of the invention, the present invention provides the micro-system, wherein the light source is at least one light emitting element installed in the plate, in the above-mentioned second aspect of the invention.

Thus, the light source can be constituted easily.

According to an eighth aspect of the invention, the present invention provides the micro-system, wherein the light emitting element is embedded in the plate, in the above-mentioned seventh aspect of the invention.

Thus, the light emitting element can be arranged near the liquid channel, and the stimulation can be certainly applied to the liquid.

According to a ninth aspect of the invention, the present invention provides the micro-system, wherein the light emitting element is arranged outside the plate, in the plate in the above-mentioned seventh aspect of the invention.

Thus, even if the plate is used once and then thrown away, the light emitting element can be used repeatedly.

According to a tenth aspect of the invention, the present invention provides the micro-system, further comprising an optical guiding path for guiding a light from the light emitting element, the optical guiding path being formed horizontally with a surface of the plate in which the liquid channel is formed, in the above-mentioned ninth aspect of the invention.

Thus, the light from a light emitting element can be efficiently introduced to the liquid channel.

According to an eleventh aspect of the invention, the present invention provides the micro-system, further comprising a plurality of light emitting elements, in the above-mentioned seventh aspect of the invention.

Thus, the stimulation can be applied in two or more parts where the liquid channels differ.

According to a twelfth aspect of the invention, the present invention provides the micro-system, further comprising:
an energy imparting means for imparting energy to the liquid; and
a change detecting means for detecting a change in a substance which causes a change by energy from said energy imparting means, wherein said stimulation applying means is controlled by said control means based on a signal from said change detecting means, in the above-mentioned first aspect of the invention.

Thus, only the liquid containing the substance can be easily divided by controlling the liquid flow based on a change in a substance which causes a change by energy from said energy imparting means.

According to a thirteenth aspect of the invention, the present invention provides the micro-system, further comprising an energy guiding path for guiding the energy from the energy imparting means, the energy guiding path being formed horizontally with a surface of the plate, in the above-mentioned twelfth aspect of the invention.

Thus, the energy from the energy imparting means can be efficiently guided to the liquid channel.

According to a fourteenth aspect of the invention, the present invention provides the micro-system, wherein the change detecting means is a fluorescence detecting element or a light receiving element, in the above-mentioned twelfth aspect of the invention.

Thus, a change in the substance which causes change by the energy from said energy imparting means is detectable.

According to a fifteenth aspect of the invention, the present invention provides the micro-system, wherein the fluorescence detecting element or the light receiving element is arranged horizontally with the surface of the plate, in the above-mentioned fourteenth aspect of the invention.

Thus, a change in the substance which causes change by the energy from said energy imparting means is detectable from a side of the liquid channel.

According to a sixteenth aspect of the invention, the present invention provides the micro-system, wherein the fluorescence detecting element or the light receiving element is arranged above the liquid channel, in the above-mentioned fourteenth aspect of the invention.

Thus, change of the substance which produces change by the energy from an energy grant means is detectable from above the liquid channel.

According to a seventeenth aspect of the invention, the present invention provides the micro-system, further comprising:
a stand for mounting the plate; and
a positioning means for deciding a position of the plate on the stand, in the above-mentioned first aspect of the invention.

Thus, the plate can be placed easily in the correct position of the stand by the positioning means. In particular, when the plate is used once and then thrown away, the effort of positioning can be saved at the time of placing the plate correctly.

In a matrix type variable liquid channel according to an eighteenth aspect of the invention, as a means for achieving the second object, the present invention provides a matrix type variable liquid channel, comprising two or more stimulation sensitive members arranged on a plate in a pattern of a two dimensional matrix.

Thus, since a wall or valve structure can be formed reversibly through a sol-gel transition at any position by stimulating the stimulation sensitive members arranged in a pattern of the two dimensional matrix, liquid channels can be easily made. Moreover, since the stimulation sensitive member is stimulated, the gelation rate of a substance having sol-gel transition properties increases. Furthermore, since the channel shape can be changed freely, preparation of liquid channels having different channel shapes is not necessary. As the stimulation sensitive member, the metal pieces which generate heat by stimulation can be used. For example, titanium, chromium, or the like can be used as these metal pieces. Additionally, when a biological reaction is taken into account, it is desirable to use titanium that does not react with a living body.

According to a nineteenth aspect of the invention, the present invention provides the matrix type variable liquid channel, wherein said stimulation sensitive members on the plate are arranged at certain intervals, in the above-mentioned eighteenth aspect of the invention.

Thus, since there is an interval between the stimulation sensitive members, gelation at any positions is facilitated.

According to a twentieth aspect of the invention, the present invention provides the matrix type variable liquid channel, wherein a size of each stimulation sensitive member ranges from 2 μm or more to 20 μm or less, in the above-mentioned nineteenth aspect of the invention.

Thus, stimulation sensitive members are stimulated so that a substance having sol-gel transition properties can be gelated in response to the size of the stimulation sensitive members. Additionally, the preferred size of each stimulation sensitive member ranges from 2 μm or more to 20 μm or less. This is because if the size of each is less than 2 μm, the thickness of the wall or valve structure becomes thin by gelation which is not desirable, while if greater than 20 μm, the thickness of the wall or valve structure becomes thick by gelation, and unless a particularly thick wall or valve structure is required, this is not necessary.

According to a twenty-first aspect of the invention, the present invention provides the matrix type variable liquid channel, wherein said stimulation sensitive members are arranged at intervals from 2 μm or more to 20 μm or less, in the above-mentioned nineteenth aspect of the invention.

According to this construction, since an area where a substance having sol-gel transition properties gelates by stimulation is larger than said stimulation sensitive members, and a gelling area connects even if said stimulation sensitive members are arranged at suitable intervals, the wall or valve structure can be formed. Moreover, the preferred interval between said stimulation sensitive members is from 2 μm or more to 20 μm or less. This is because the interval is narrow if the interval is less than 2 μm, while it is difficult to connect a gelling area with the interval over 20 μm.

According to a twenty-second aspect of the invention, the present invention provides the matrix type variable liquid channel, wherein said stimulation sensitive members are formed by vapor deposition, sputtering, Chemical Vapor Deposition (CVD), plating, plasma polymerization, or screen-printing, in the above-mentioned nineteenth aspect of the invention.

Thus, said stimulation sensitive members can be easily formed on a plate by using vapor deposition, sputtering, Chemical Vapor Deposition (CVD), plating, plasma polymerization, or screen-printing.

According to a twenty-third aspect of the invention, the present invention provides the matrix type variable liquid channel, wherein said stimulation sensitive member is stimulated by applying a voltage or irradiating a light thereto, in the above-mentioned eighteenth aspect of the invention.

Thus, since said stimulation sensitive member is stimulated by applying a voltage or irradiating a light thereto, the temperature of said stimulation sensitive member can be adjusted and a sol-gel transition can be easily initiated.

In a matrix type variable liquid channel system according to a twenty-fourth aspect of the invention, the present invention provides the matrix type variable liquid channel system comprising:
a matrix type variable liquid channel which comprises two or more stimulation sensitive members arranged on a plate in a pattern of a two dimensional matrix;
a detecting means for detecting a substance on the plate;
a stimulation applying means for applying stimulation to the stimulation sensitive members; and
a control means for controlling the stimulation applying means based on the signal from the detecting means.

Thus, said stimulation sensitive members arranged in a pattern of a two dimensional matrix is stimulated by the stimulation applying means so that a wall or valve structure through a sol-gel transition can be formed reversibly at positions corresponding to said stimulation sensitive members. Therefore, the liquid channel can be easily made. Moreover, since the stimulation sensitive member is stimulated, the gelation rate of a substance having sol-gel transition properties increases. Additionally, since the channel shape can be changed freely by controlling the stimulation applying means, preparation of a liquid channel having different channel shapes is not necessary. Furthermore, a substance can be detected at any positions on a plate, and a desired sample substance is easily separated or analyzed. As a stimulation sensitive member, metal pieces which generate heat by stimulation can be used. For example, titanium, chromium, or the like can be used as these metal pieces. Additionally, when a biological reaction is taken into account, it is desirable to use titanium which does not react with a living body.

According to a twenty-fifth aspect of the invention, the present invention provides the matrix type variable liquid channel system, wherein said stimulation sensitive members on the plate are arranged at certain intervals, in the above-mentioned twenty-fourth aspect of the invention.

Thus, since there is an interval between stimulation sensitive members, gelation at any positions is facilitated. Moreover, since the channel shape can be easily changed, a substance can be detected at any positions on a plate, and a desired sample substance can be easily separated or analyzed.

According to a twenty-sixth aspect of the invention, the present invention provides the matrix type variable liquid channel system, wherein a size of each stimulation sensitive member ranges from 2 μm or more to 20 μm or less, in the above-mentioned twenty-fifth aspect of the invention.

Thus, stimulation sensitive members are stimulated so that a substance having sol-gel transition properties can be gelated in response to the size of the stimulation sensitive members. Additionally, the preferred size of each stimulation sensitive member ranges from 2 μm or more to 20 μm or less. This is because if the size of each is less than 2 μm, the thickness of the wall or valve structure becomes thin by gelation which is not desirable, while if greater than 20 μm, the thickness of the wall or valve structure becomes thick by gelation, and unless a particularly thick wall or valve structure is required, this is not necessary. Moreover, since the channel shape can be easily changed, a substance can be detected at any positions on a plate, and a desired sample substance can be easily separated or analyzed.

According to a twenty-seventh aspect of the invention, the present invention provides the matrix type variable liquid channel system, wherein said stimulation sensitive members are arranged at intervals from 2 μm or more to 20 μm or less, in the above-mentioned twenty-fifth aspect of the invention.

According to this construction, since an area where a substance having sol-gel transition properties gelates by stimulation is larger than said stimulation sensitive members, and a gelling area connects even if said stimulation sensitive members are arranged at suitable intervals, the wall or valve structure can be formed. Moreover, the preferred interval between said stimulation sensitive members is from 2 μm or more to 20 μm or less. This is because the interval is narrow if the interval less than 2 μm, while it is difficult to connect a gelling area with the interval over 20 μm. Moreover, since the channel shape can be easily changed, a substance can be detected at any positions on a plate, and a desired sample substance can be easily separated or analyzed.

According to a twenty-eighth aspect of the invention, the present invention provides the matrix type variable liquid channel system, wherein said stimulation sensitive members are formed by vapor deposition, sputtering, Chemical Vapor Deposition (CVD), plating, plasma polymerization, or screen-printing, in the above-mentioned twenty-fifth aspect of the invention.

Thus, said stimulation sensitive members can be easily formed on a plate by using vapor deposition, sputtering, Chemical Vapor Deposition (CVD), plating, plasma polymerization, or screen-printing. Furthermore, by constructing the invention in this manner, a system is able to be cheaply manufactured.

According to a twenty-ninth aspect of the invention, the present invention provides the matrix type variable liquid channel system, wherein said stimulation sensitive member is stimulated by said stimulation applying means applying stimulation thereto, said stimulation being the application of voltage, or irradiation of light, in the above-mentioned twenty-fourth aspect of the invention.

According to this construction, since it is configured so that stimulation may be applied to said stimulation sensitive member by applying voltage or irradiating a light as said stimulation applying means, the temperature of said stimulation sensitive member can be adjusted and a sol-gel transition can be easily initiated. Furthermore, by constructing the invention in this manner, since the channel shape can be easily changed, a substance can be detected at any positions on a plate, and a desired sample substance can be easily separated or analyzed.

In a nano-aperture film according to a thirtieth aspect of the invention, as a means for achieving the third object, the present invention provides the nano-aperture film, comprising a thin film which does not transmit light and in which at least one nano-aperture is formed.

According to this construction, by forming the maximum opening width of a nano-aperture smaller than the wavelength of the excitation light and irradiating the nano-aperture with excitation light, an evanescent field is generated through the nano-aperture. Thus using the evanescent field, it is possible to irradiate a fluorescent biomolecule with an excitation light in a smaller region than the wavelength of the excitation light.

According to a thirty-first aspect of the invention, the present invention provides the nano-aperture film, wherein the thin film is combined with a transparent plate, in the above-mentioned thirtieth aspect of the invention.

Thus, the manufacturing and handling of a thin film can be improved by supporting the thin film on the plate. Moreover, since the plate is transparent, it does not prevent the transmission of excitation light.

According to a thirty-second aspect of the invention, the present invention provides the nano-aperture film, wherein a plurality of nano-apertures are provided and arranged at substantially equal intervals, in the above-mentioned thirtieth aspect of the invention.

According to this construction, since the fluorescence of a fluorescent biomolecule can be observed in the any of the nano-apertures among two or more nano-apertures, the positioning of said fluorescence detecting means can be easily performed.

Moreover, in the case where the interval of the nano-aperture is set the same as a resolution of a fluorescence detecting means or larger than the resolution of a fluorescence detecting means, the fluorescence of each fluorescent biomolecule excited by each nano-aperture is separated so that an interaction between biomolecules can be detected at the level of a single molecule.

According to a thirty-third aspect of the invention, the present invention provides the nano-aperture film, wherein a maximum opening width of the nano-aperture is 200 nm or less, in the above-mentioned thirtieth aspect of the invention.

Thus, the maximum opening width of the nano-aperture can be set smaller than the wavelength of the excitation light.

In a device for analyzing a biomolecular interaction according to a thirty-fourth aspect of the invention, the present invention provides the device for analyzing a biomolecular interaction comprising:
an excitation light generating means for generating excitation light;
a nano-aperture film which comprises a thin film which does not transmit light and in which at least one nano-aperture is formed, wherein a maximum opening width of the nano-aperture is smaller than the wavelength of the excitation light; and
a fluorescence detecting means for detecting fluorescence.

According to this construction, the nano-aperture of the nano-aperture film, with a maximum opening width smaller than the wavelength of the excitation light, can be irradiated with excitation light from the excitation light generating means, and the evanescent field generated in the nano-apertures can be used to irradiate the fluorescent biomolecule with the excitation light in an area smaller than the wavelength of the excitation light, and the fluorescence emitted from the fluorescent biomolecule can be detected with the fluorescence detecting means. Moreover, by irradiating the fluorescent biomolecule with the excitation light in an area smaller than the wavelength of the excitation light, the concentration in the aqueous solution including the fluorescent biomolecule may be increased. Furthermore, the influence of the nonspecific absorption of the fluorescent biomolecule in a surface of the plate such as a glass surface is able to be prevented, and hence detection or determination of the biomolecular interaction can be performed reliably.

According to a thirty-fifth aspect of the invention, the present invention provides the device for analyzing a biomolecular interaction, wherein a plurality of nano-apertures are provided and arranged at equal intervals, and the interval between the nano-apertures is the same as the resolution of the fluorescence detecting means or larger than the resolution of the fluorescence detecting means, in the above-mentioned thirty-fourth aspect of the invention.

According to this construction, since the fluorescence of the fluorescent biomolecule is observable in the arbitrary nano-apertures of a plurality of nano-apertures, alignment by a fluorescence detecting means is easy. Moreover, since the interval between the nano-apertures is the same as the resolution of the fluorescence detecting means or larger than the resolution of the fluorescence detecting means, the fluorescence of each fluorescent biomolecule excited by each nano-aperture can be separated, and the interaction between biomolecules can be detected at the level of a single molecule.

In a method of analyzing a biomolecular interaction according to a thirty-sixth aspect of the invention, the present invention provides the method of analyzing a biomolecular interaction comprising the steps of:
generating an evanescent field by an excitation light from a nano-aperture smaller than a wavelength of the excitation light;
exciting a fluorescent biomolecule which passes through a certain region of the evanescent field by Brownian motion; and
detecting fluorescence of the fluorescent biomolecule.

Thus, the fluorescent biomolecule in a region smaller than the wavelength of the excitation light can be irradiated with the excitation light, and the interaction between biomolecules can be detected at the level of a single molecule.

In a method of analyzing a biomolecular interaction according to a thirty-seventh aspect of the invention, the present invention provides the method of analyzing a biomolecular interaction comprising the steps of:
generating an evanescent field by an excitation light from a nano-aperture smaller than a wavelength of the excitation light;
exciting a first fluorescent biomolecule allowed to attach to the nano-aperture, and a second fluorescent biomolecule which is in a certain region of the evanescent field and interacts to the first fluorescent biomolecule; and
detecting fluorescence of these first and second fluorescent biomolecules, respectively.

Thus, the fluorescent biomolecule in a region smaller than the wavelength of the excitation light can be irradiated with the excitation light, and the interaction between biomolecules can be detected at the level of a single molecule.

### BRIEF DESCRIPTION OF THE DRAWINGS

FIG. 1 is a top view of a micro-system showing a first embodiment of the present invention, and a sectional view along line A-A thereof.

FIG. 2 is a sectional view of a liquid channel along line B-B of FIG. 1 according to the first embodiment of the present invention.

FIG. 3 is a sectional view of the liquid channel along line B-B of FIG. 1 according to the first embodiment of the present invention.

FIG. 4 is a sectional view of the liquid channel along line B-B of FIG. 1 on a micro-system showing a second embodiment of the present invention.

FIG. 5 is a top view of a micro-system showing a third embodiment of the present invention.

FIG. 6 is a sectional view of a liquid channel along line C-C of FIG. 5 according to the third embodiment of the present invention.

FIG. 7 is a sectional view of the liquid channel along line C-C of FIG. 5 showing a modified example according to the third embodiment of the present invention.

FIG. 8 is a top view of a micro-system showing a fourth embodiment of the present invention.

FIG. 9 is a top view of the micro-system showing a modified example according to the fourth embodiment of the present invention.

FIG. 10 is a top view of the micro-system showing another modified example according to the fourth embodiment of the present invention.

FIG. 11 is a top view of a micro-system showing a fifth embodiment of the present invention.

FIG. 12 is a top view of a micro-system showing a sixth embodiment of the present invention.

FIG. 13 is a plain view of a matrix type variable liquid channel showing a seventh embodiment of the present invention.

FIG. 14 is a sectional view of the matrix type variable liquid channel along line E-E of FIG. 13 according to the seventh embodiment of the present invention.

FIG. 15 is a plan view showing a state where the matrix type variable liquid channel is embedded in a basic stand according to the seventh embodiment of the present invention.

FIG. 16 is a schematic diagram of a stimulation detecting means for applying stimulation by voltage application, according to the seventh embodiment of the present invention.

FIG. 17 is a schematic diagram showing a state where a sample flows through a matrix type variable liquid channel, according to the seventh embodiment of the present invention.

FIG. 18 is a schematic diagram of a system for a matrix type variable liquid channel showing an eighth embodiment of the present invention.

FIG. 19 is a schematic diagram of the matrix type variable liquid channel showing a state of sample mass movement in an application example 1 according to the eighth embodiment of the present invention.

FIG. 20 is a schematic diagram of the matrix type variable liquid channel showing a state of sample mass movement in an application example 2 according to the eighth embodiment of the present invention.

FIG. 21 is a schematic diagram of a matrix type variable liquid channel system showing a state after sample mass movement in the application example 2 according to the eighth embodiment of the present invention.

FIG. 22 is a schematic diagram of a matrix type variable liquid channel system showing a state in which a sample moves in an application example 3 according to the eighth embodiment of the present invention.

FIG. 23 is a plain view showing a state in which a sample is surrounded by a wall in the application example 3 according to the eighth embodiment of the present invention.

FIG. 24 is a plain view showing a state in which a liquid channel has been transformed in the application example 3 according to the eighth embodiment of the present invention.

FIG. 25 is a schematic diagram showing a state in which a sample flows through a matrix type variable liquid channel in an application example 4 according to the eighth embodiment of the present invention.

FIG. 26 is a figure showing a state in which electrocataphoresis is carried out in the application example 4 according to the eighth embodiment of the present invention.

FIG. 27 is a front view of a nano-aperture film showing a ninth embodiment of the present invention.

FIG. 28 is a schematic diagram showing the generation of an evanescent field through nano-apertures according to the ninth embodiment of the present invention.

FIG. 29 is a schematic diagram of a measurement principle of FCS using nano-apertures in a device for analyzing biomolecular interaction, showing a tenth embodiment of the present invention.

FIG. 30 is a schematic diagram of a FCS device with a nano-aperture according to the tenth embodiment of the present invention.

FIG. 31 is a schematic diagram of a measurement principle of FCCS using nano-apertures in a device for analyzing biomolecular interaction, showing an eleventh embodiment of the present invention.

FIG. 32 is a schematic diagram of a FCCS device with a nano-aperture according to the eleventh embodiment of the present invention.

FIG. 33 is a schematic diagram of the measurement principle of a single fluorescent molecule imaging method using the nano-apertures of the device for analyzing a biomolecular interaction, showing a twelfth embodiment of the present invention.

FIG. 34 is a schematic diagram of a single fluorescent molecule imaging device using the nano-apertures according to the twelfth embodiment of the present invention.

FIG. 35 is a schematic diagram of a biomolecule observing method which uses the conventional evanescent field with a total reflection.

FIG. 36 is a schematic diagram showing a conventional principle of FCS.

### DESCRIPTION OF PREFERRED EMBODIMENTS

Description will now be directed to a micro-system, a nano-aperture film, a device for analyzing interaction between biomolecules, and a method of analyzing interaction between biomolecules, according to embodiments of the present invention with reference to the attached drawings.

### Embodiment 1

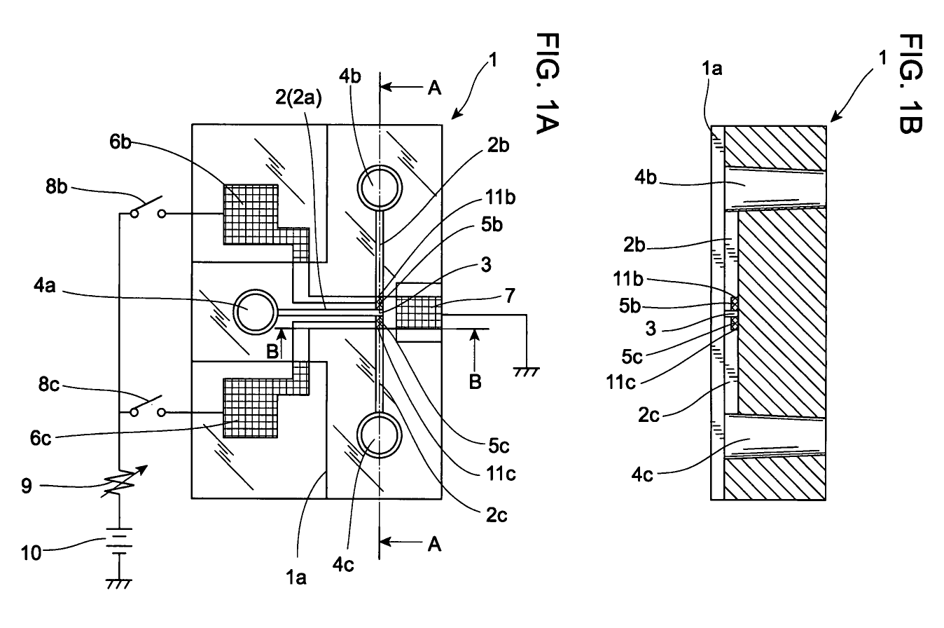

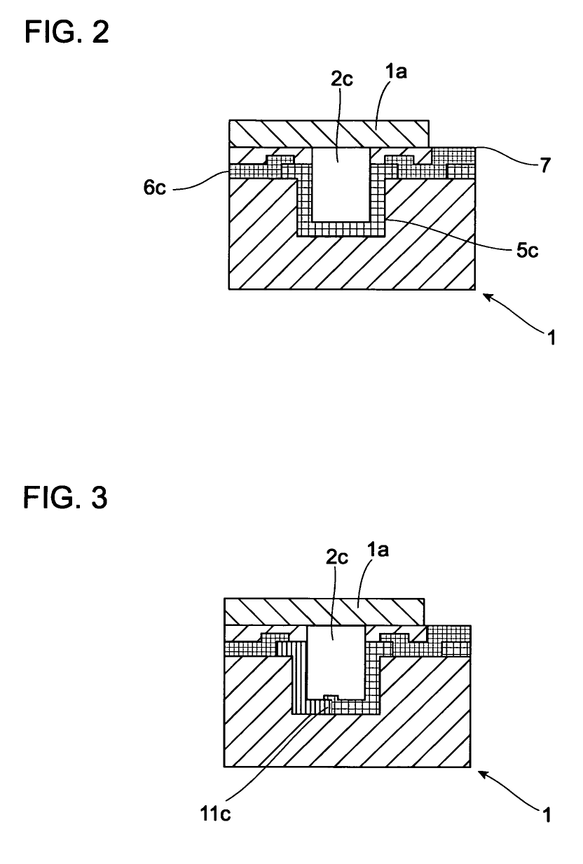

Hereafter, the present invention is explained in detail. First, based on FIG. 1 and FIG. 2, a micro-system in a first embodiment of the present invention is explained. Numeral 1 denotes a plate consisting of glass, silicone, and the like. The size of the plate 1 is about 10 mm on its side. A liquid channel 2 is formed on this plate 1. The width of a section of this liquid channel 2 is about 30 μm and the depth is about 5 μm. This liquid channel 2 comprises: a liquid channel 2a; and two liquid channels 2b and 2c branching from the liquid channel 2a at a branch point 3. Through passages 4a, 4b, and 4c are each formed by penetrating through the plate 1 from its top to its bottom. The through passages 4a, 4b, and 4c are located on the opposite sides of the branch point 3 to the liquid channels 2a, 2b, and 2c respectively. A cover component 1a made of glass, etc. is placed closely on the upper surface of the plate 1, covering the liquid channels 2a, 2b, and 2c and the through passages 4a, 4b, and 4c.

Each of micro-heaters 5b, 5c that are heat sources serving as a stimulation applying means are provided at the bottom and side of the liquid channels 2b, 2c in a portion adjacent to the branch point 3. These micro-heaters 5b and 5c are electrically connected to positive electrodes 6b and 6c respectively, and connected to a negative electrode 7. The negative electrode 7 is grounded. End sides of switches 8b and 8c are connected to the positive electrodes 6b and 6c respectively. The other end side of the switches 8b and 8c are connected to a direct-current power supply 10. The switches 8b and 8c, and a variable resistor 9 are configured so that operation may be controlled by a control means not shown in the figure.

As shown in FIG. 3, each of thermo-couples 11b and 11c that are heat sensors serving as a stimulation detecting means are provided next to the micro-heaters 5b and 5c at the bottom and side of the liquid channels 2b and 2c in a portion adjacent to the branch point 3. These thermo-couples 11b, 11c are electrically connected to the control means. The control means controls the voltage applied to the micro-heaters 5b, 5c by controlling the variable resistor 9 based on a signal from these thermo-couples 11b, 11c.

Next an operation of the invention is explained below. First, liquid for flowing through the liquid channel 2 is introduced from the through passage 4a using a syringe pump (not shown), etc. A heat reversible hydro-gel material is applied into this liquid. The heat reversible hydro-gel material causes sol-gel transition at 37 degrees C. At less than 37 degrees C. it becomes a sol, and at more than 37 degrees C. it becomes a gel. A material completely having a heat reversibility property related with change in temperature is preferred for the heat reversible hydro-gel material. For example the material disclosed in Japanese Publication Patent No. H05-262882 can be used. When the temperature for sol-gel transition is too low, it is not preferred because it becomes a gel at room temperature. When too high, it is also not preferred because a sample such as protein contained in the liquid becomes heat denatured during gelation. The temperature for sol-gel transition may be accordingly changed to an appropriate temperature by choosing the heat reversible hydro-gel material to be used. Also the type, concentration, etc. of the heat reversible hydro-gel material to be used can be chosen and adjusted so that it may not react with a sample included in the liquid passing through the liquid channel 2, and it may not affect it.

When for example the switch 8b is turned on by the control means, the voltage is applied to the micro-heater 5b formed in the liquid channel 2b to heat the liquid on the micro-heater 5b. This heat causes the heat reversible hydro-gel material contained in the liquid to drastically turn into a gel. Thereafter the gelled heat reversible hydro-gel material blocks the portion adjacent to the branch point 3 of the liquid channel 2b. Therefore the liquid flows through the liquid channel 2c. At this time, the control means controls the variable resistor 9 based on the signal from the thermo-couple 11b adjacent to the micro-heater 5b to apply heat for an appropriate amount of stimulation to the liquid. Therefore, there is no possibility that the heat reversible hydro-gel material does not gelate because the amount of heat applied to the liquid is too small. There is also no possibility that the sample contained in the liquid is heat denatured because the amount of the heat applied to the liquid is too large. On the other hand, if the amount of heat given to the liquid is too large, it may take much time for the heat reversible hydro-gel material to gelate after the voltage applied to the micro-heaters 6b is stopped, and therefore this is not preferred.

When the switch 8b is turned of and the switch 8c is turned on, the voltage applied to the micro-heaters 5b is stopped, the liquid on the micro-heaters 5b becomes cold to solate, and a voltage is applied to the micro-heaters 5c formed on the liquid channel 2c. Thereafter by heating the liquid on the micro-heater 5c, the gelled heat reversible hydro-gel material blocks the portion adjacent to the branch point 3 of the liquid channel 2c. Therefore the liquid flows through the liquid channel 2b. At this time, the control means controls the variable resistor 9 based on the signal from a thermo-couple 11c adjacent to the micro-heater 5c to apply an appropriate amount of the heat for the stimulation to the liquid.

The more minute the liquid channel 2 is, the more quickly the sol-gel transition occurs by the heat reversible hydro-gel material. It is possible to switch the sol-gel transition by the millisecond when the width of a section of the liquid channel 2 is about 30 μm and the depth is about 5 μm, as with the embodiment in this invention. Therefore, the liquid channels 2b and 2c can be changed very quickly, and hence it becomes possible to certainly isolate the required sample in the liquid by using this.

As mentioned above, according to this embodiment, a micro-system has the micro-heaters 5b and 5c for serving as the stimulation applying means for applying stimulation to the liquid flowing through the liquid channels 2b and 2c formed on the plate 1, the liquid flow being controlled by the stimulation from the micro-heaters 5b and 5c. The micro-system comprises a control means for controlling an amount of stimulation applied to the liquid by the micro-heaters 5b and 5c. Thus this control means can provide an appropriate amount of stimulation by electrically controlling an amount of stimulation applied to the liquid from the micro-heaters 5b and 5c.

The micro-system also has thermo-couples 11b and 11c, serving as stimulation detecting means for detecting an amount of stimulation, and the control means controls the micro-heaters 5b and 5c based on a signal from the thermo-couples 11b and 11c. Thus an appropriate amount of stimulation can be provided. By using the micro-heaters 5b and 5c, stimulation can be certainly applied to liquid.

Also by using the thermo-couples 11b and 11c, the amount of stimulation applied to the liquid by the micro-heaters 5b and 5c can be reliably detected, which enables a heat sensor to be easily constructed.

### Embodiment 2

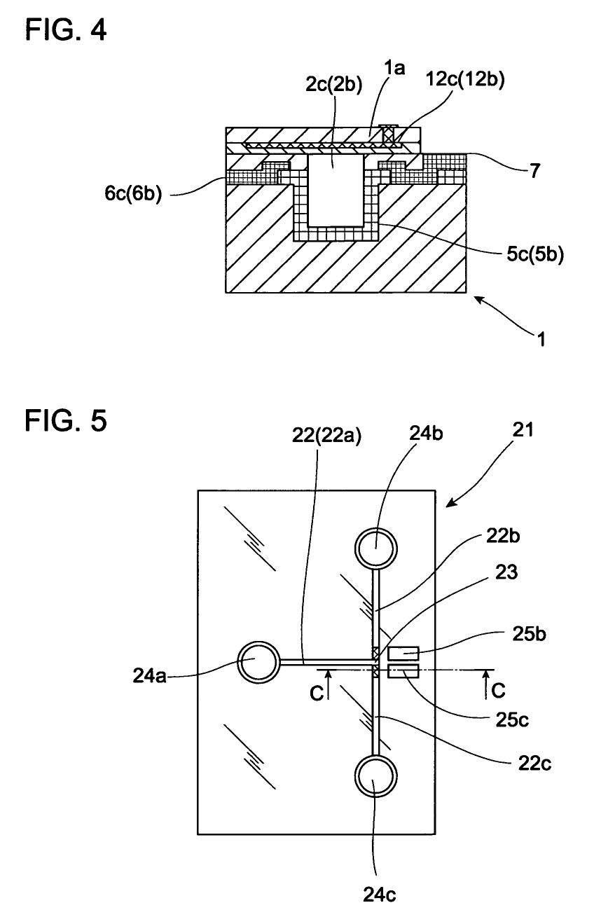

Next a second embodiment of the present invention is explained. The same reference symbols are given to the same portions as in the above first embodiment, and detailed explanation is omitted. In this embodiment, as shown in FIG. 4, heat sensitive semiconductors 12b and 12c are provided for serving as a stimulation detecting means instead of the thermo-couples 11b and 11c in the first embodiment. These heat sensitive semiconductors 12b and 12c are formed in the cover component 1a above the micro-heaters 5b and 5d. Also instead of these heat sensitive semiconductors 12b and 12c, an infrared ray sensitive sensor may be provided.

As mentioned above, according to this embodiment, since the heat sensitive semiconductors 12b and 12c or an infrared ray sensitive sensor are used, the amount of stimulation can be reliably detected.

### Embodiment 3

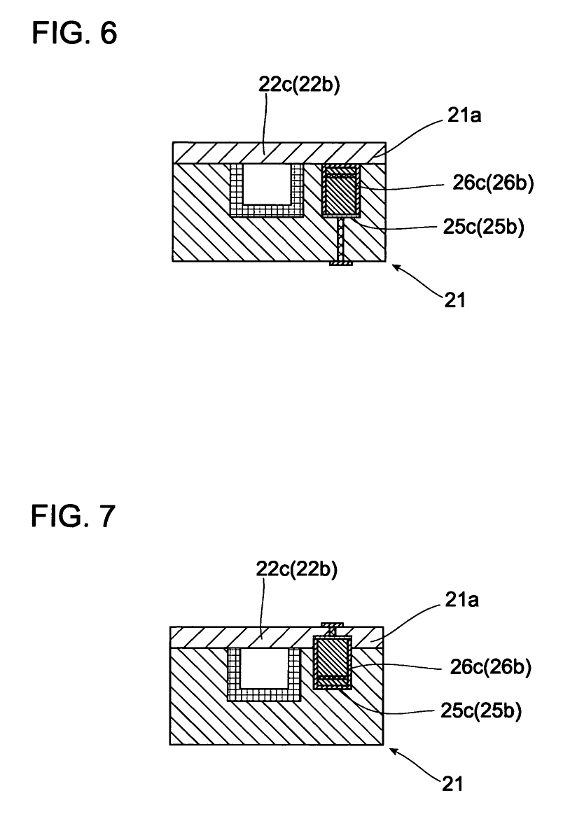

Next, a third embodiment of the present invention is explained. In FIG. 5 and FIG. 6, numeral 21 denotes a plate which comprises a transparent material, such as glass. The size of the plate 21 is about 10 mm on its side. A liquid channel 22 is formed on this plate 21. The width of a section of this liquid channel 22 is about 30 μm and the depth is about 5 μm. This liquid channel 22 comprises a liquid channel 22a, and two liquid channel 22b and 22c branching from this liquid channel 22a at a branch point 3. Through passages 24a, 24b, and 24c are each formed by penetrating through the plate 21 from its top to its bottom. The through passages 24a, 24b, and 24c are located on the opposite sides of the branch point 23 to the liquid channels 22a, 22b, and 22c respectively. A cover component 21a made from a transparent material such as glass is placed closely on the upper surface of the plate 21, covering the liquid channels 22a, 22b, and 22c and the through passages 24a, 24b, and 24c.

Semiconductor lasers 25b, 25c that are light emitting elements or light sources serving as a stimulation applying means are provided next to the liquid channels 22b, 22c in a portion adjacent to the branch point 23. As shown in FIG. 6, the semiconductor lasers 25b and 25c are embedded in the plate 21, and are comprised so that the liquid channels 22b and 22c in the portion adjacent to the branch point 23 may be irradiated with the infrared laser light from each light-emitting part 26b and 26c of the semiconductor lasers 25b and 25c. The semiconductor lasers 25b and 25c are constituted so that a control means not shown in the figure can control their operation. As shown in FIG. 7, the semiconductor lasers 25b and 25c may be formed by embedding them between the plate 21 and the cover component 21a.

Moreover, the infrared ray sensitive sensors (not shown) are respectively provided in the area irradiated with the infrared laser light using the semiconductor lasers 25b and 25c of the liquid channels 22b and 22c. The infrared ray sensitive sensors are electrically connected to the control means, and the control means is constructed so that it can control the operation of the semiconductor lasers 25b and 25c based on the signal from the infrared ray sensitive sensors.

Next the operation is explained below. Firstly a liquid for flowing through the liquid channel 22 is introduced from the through passage 24a using a syringe pump (not shown), or the like. A heat reversible hydro-gel material is added to this liquid. The heat reversible hydro-gel material causes sol-gel transition at 37 degrees C. At less than 37 degrees C. it becomes a sol, and more than 37 degrees C. it becomes a gel. Since the heat reversible hydro-gel material is the same as that used in the first embodiment, detailed explanation is omitted.

Using the control means, for example, when the semiconductor laser 25b is turned on, the liquid in the portion adjacent to the branch point 23 of the liquid channel 22b is irradiated with infrared rays of laser light from the semiconductor laser 25b to heat the liquid in the portion. This heat causes the heat reversible hydro-gel material contained in the liquid to drastically turn to a gel. Thereafter the gelled heat reversible hydro-gel material blocks the portion adjacent to the branch point 23 of the liquid channel 22b. Therefore the liquid flows through the liquid channel 22c. At this time the control means controls the semiconductor laser 25b based on the signal from the infrared ray sensitive sensor to apply the infrared laser light as an appropriate amount of stimulation to the liquid. Therefore, there is no possibility that the heat reversible hydro-gel material does not turn to a gel when the infrared laser light applied to the liquid is too small. There is also no possibility that the sample contained in the liquid is heat denatured since the infrared laser light applied to the liquid is too large.

When the semiconductor laser 25b is turned off and the semiconductor laser 25c is turned on, the liquid in the portion adjacent to the branch point 23 of the liquid channel 22b where the infrared laser light having been irradiated until then, gets colds to gelate. Thereafter the infrared laser light is applied to the liquid in the portion adjacent to the branch point 23 of the liquid channel 22c from the semiconductor laser 25c to heat it. This heat causes the heat reversible hydro-gel material contained in the liquid to drastically turn to a gel. Thereafter the gelled heat reversible hydro-gel material blocks the portion adjacent to the branch point 23 of the liquid channel 22c. Therefore the liquid flows through the liquid channel 22b. At this time, the control means controls the semiconductor laser 25c based on the signal from the infrared ray sensitive sensor to apply the infrared laser light as an appropriate stimulation to the liquid.

As mentioned above, according to this embodiment, a micro-system comprises the semiconductor lasers 25b and 25c being a stimulation applying means for applying stimulation to a liquid flowing in the liquid channels 22b and 22c formed in the plate 21, the liquid flow being controlled by the stimulation from the stimulation applying means, wherein the semiconductor lasers 25b and 25c comprise a control means for electrically controlling an amount of stimulation applied to the liquid. By electrically controlling the amount of stimulation applied to the liquid by the semiconductor lasers 25b and 25c using the control means, it is possible to give an appropriate amount of stimulation.

Also a micro-system comprises an infrared ray sensitive sensor serving as a stimulation detecting means, for detecting the amount of stimulation, and said semiconductor lasers 25b and 25c are controlled by said control means based on a signal from said infrared ray sensitive sensor. Using the semiconductor lasers 25b and 25c serving as the light emitting element, it is possible to reliably give stimulation to the liquid.

Moreover, by using the infrared ray sensitive sensor, it is possible to reliably detect the amount of stimulation applied to the liquid by the semiconductor lasers 25b and 25c.

Furthermore, because the semiconductor lasers 25b and 25c are provided in the plate 21, it is possible to easily construct a light source.

Also because the semiconductor lasers 25b and 25c are embedded in the plate 21, it is possible to arrange the semiconductor lasers 25b and 25c near the liquid channels 22b and 22c, and to reliably give stimulation to the liquid.

### Embodiment 4

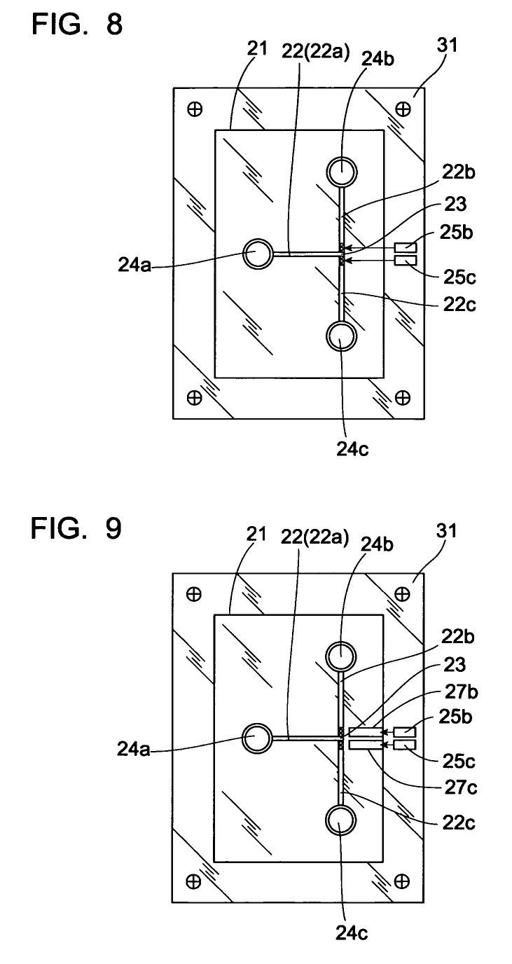

Next, a fourth embodiment of the present invention is explained. The same reference symbols are given to the same portions as in the above third embodiment, and detailed explanation is omitted. In this embodiment, as shown in FIG. 8, a plate 21 is mounted on a stand 31, and semiconductor lasers 25b and 25c are arranged on the stand 31 outside the plate 21. In this embodiment, as shown in FIG. 9, optical introducing paths 27b and 27c may be provided for guiding infrared laser light emitted from the semiconductor lasers 25b and 25c to liquid channels 22b and 22c. These optical guiding paths 27b and 27c are formed horizontally with the surface of the plate 21 in which the liquid channels 22b and 22c are formed. These optical guiding paths 27b and 27c are provided by forming cavities in the plate 21, and placing metal foil on that side for reflecting infrared laser light. Or the cavity may be filled with a material whose refractive index is lower than the material forming the plate 21 for inducing total internal reflection of the infrared laser light on the side of the cavity. Conversely, the cavity may be configured so as to be filled with a material whose refractive index is higher than the material forming the plate 21 for inducing total internal reflection of the infrared laser light on the side of the cavity.

As mentioned above, according to this embodiment, the semiconductor lasers 25b and 25c are arranged outside the plate 21. The plate 21 may be used as a disposable one, and the semiconductor lasers 25b and 25c may be repeatedly used.

The optical guiding paths 27b and 27c for guiding light from the semiconductor lasers 25b and 25c are formed horizontally with the surface of the plate 21 in which the liquid channels 22b and 22c are formed. It is possible to efficiently guide the light from the semiconductor lasers 25b and 25c to the liquid channels 22b and 22c.

Since the micro-system comprises a plurality of light emitting elements, it is possible to apply the stimulation at a number of different sites in the liquid channels 22b and 22c.

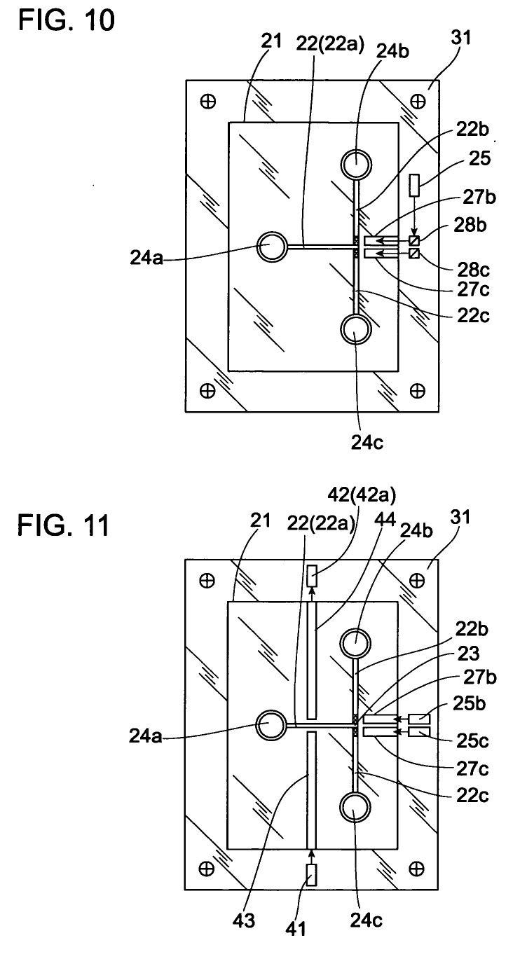

As shown in FIG. 10, by controlling mirrors 28b and 28c by a control means not shown in the figure, the infrared laser light from one semiconductor laser 25 may be selectively emitted to either of the two liquid channels 22b and 22c.

### Embodiment 5

Next, a fifth embodiment of the present invention is explained. The same reference symbols are given to the same portions as in the above third and fourth embodiments, and detailed explanation thereof is omitted. In this embodiment, as shown in FIG. 11, a semiconductor laser 41 being an energy imparting means for imparting excitation light as energy to liquid in a liquid channel 22a; and a fluorescence detecting element 42 being a change detecting means for detecting fluorescence from a substance excited by the excitation light from this semiconductor laser 41, are arranged on a mounting stand 31 outside of the plate 21 The fluorescence detecting element 42 is configured so as to switch to an excitation light detecting element 42a for detecting the excitation light from the semiconductor laser 41 as necessary. As mentioned hereinafter, this excitation light detecting element 42a acts as a positioning means for deciding a position of the plate 21 on the stand 31. Instead of the fluorescence detecting element 42, a light receiving element may be configured as the change detecting means.

An energy introducing path 43 for guiding excitation light emitted from the semiconductor laser 41 to the liquid channels 22a is formed on the plate 21. This energy guiding path 43 is arranged horizontally with the surface of the plate 21 in which the liquid channel 22a is formed. This energy introducing path 43 is provided by forming a cavity in the plate 21, and placing metal foil on that side for reflecting excitation light. Or the cavity may be configured so as to be filled with a material whose refractive index is lower than the material forming the plate 21 for inducing total internal reflection of the excitation light on the side of the cavity. Conversely, the cavity may be configured so as to be filled with a material whose refractive index is higher than the material forming the plate 21 for inducing total internal reflection of the excitation light on the side of the cavity.

Furthermore a fluorescence guiding path 44 for guiding the fluorescence emitted from the substance in the liquid of the liquid channel 22a to a fluorescence detecting element 42 is provided on the plate 21. The fluorescence is excited by excitation light from the semiconductor laser 41. This fluorescence guiding path 44 is formed horizontally with the surface of the plate 21 in which the liquid channel 22a is formed. As with the above energy introducing path 43, this fluorescence guiding path 44 is provided by forming a cavity in the plate 21, and placing metal foil on that side for reflecting excitation light. Or the cavity may be configured so as to be filled with a material whose refractive index is lower than the material forming the plate 21 for inducing total internal reflection of the excitation light on the side of the cavity. Conversely, the cavity may be configured so as to be filled with a material whose refractive index is higher than the material forming the plate 21 for inducing total internal reflection of the excitation light on the side of the cavity. The energy introducing path 43 is formed in alignment with the fluorescence guiding path 44.

The semiconductor laser 41 is controlled by the control means not shown in the figure to control the semiconductor lasers 25b and 25c based on the signal from the fluorescence detecting element 42.

Next the operation is explained. First the plate 21 is mounted on the stand 31. At this time the plate 21 is fixed at a position where the excitation light from the semiconductor laser 41 via the energy introducing path 43 and the fluorescence guiding path 44 can be detected most strongly in the excitation light detecting element 42a. Thus by using the semiconductor laser 41 and the excitation light detecting element 42a as a positioning means like this, it is possible to precisely mount the plate 21 in a predetermined position on the stand 31 when replacing the plate 21.

The liquid for flowing through the liquid channel 22 is introduced from through passage 24a using a syringe pump not shown in the figure or the like. A heat reversible hydro-gel material is added to this liquid. The heat reversible hydro-gel material causes sol-gel transition at 37 degrees C. At less than 37 degrees C. it becomes a sol, and at more than 37 degrees C. it becomes a gel. Because the heat reversible hydro-gel material is the same as that used in the first embodiment, detailed explanation is omitted.

Hereinafter a case of sorting a sample in this liquid is described as an example. The sample may be, for example, protein molecule, and be labeled with a fluorescent substance if necessary. The speed for introducing the liquid from the syringe pump, or the like, is adjusted beforehand so that the liquid may flow into the liquid channel 22a at about 2 mm/second. For the speed of flow, 100 mm/second or less is suitable. However, the speed of flow is a value which is decided by a detector configuration and a channel structure, and is not essential for this invention. Excitation light is emitted to the liquid flowing through the liquid channel 22a, from the semiconductor laser 41 through the energy introducing path 43. Thereafter the fluorescence from a target sample through the fluorescence guiding path 44 is detected by the fluorescence detecting element 42. The fluorescence is detected by this fluorescence detecting element 42, for example, for every 10 ms, and the result is outputted to the control means. However, the cycle for detecting the fluorescence is a value which is not decided by the detector configuration, and is not essential for the invention.

When the fluorescence is not detected from the target sample, the control means turns on the semiconductor laser 25b, and the infrared laser light is emitted from the semiconductor laser 25b to the liquid in the portion adjacent to the branch point 23 of the liquid channel 22b to heat it. By this heating, the heat reversible hydro-gel material included in the liquid drastically turns into a gel, and this gelled heat reversible hydro-gel material blocks the part near the branch point 23 of the liquid channel 22b. Therefore, the liquid flows into the side of the liquid channel 22c, and this liquid is discarded from the through passage 24c. At this time, the control means controls the semiconductor laser 25b based on a signal from the infrared ray sensitive sensor to apply the infrared laser light being an appropriate amount of stimulation to the liquid.

When fluorescence is detected from the target sample, the control means turns off the semiconductor laser 25b and turns on the semiconductor laser 25c. Thereafter the liquid in the portion adjacent to the branch point 23 of the liquid channel 22b, the liquid having been irradiated with the infrared laser light by then, gets cold to drastically solate. The infrared laser light is emitted from the semiconductor laser 25c to the liquid in the portion adjacent to the branch point 23 of the liquid channel 22c to heat it. By this heating, the heat reversible hydro-gel material included in the liquid drastically turns into a gel, and this gelled heat reversible hydro-gel material blocks the part near the branch point 23 of the liquid channel 22c. Therefore, the liquid flows into the side of the liquid channel 22b, and this liquid is collected from the through passage 24b. At this time, the control means controls the semiconductor laser 25c based on the signal from the infrared ray sensitive sensor to apply the infrared laser light being the appropriate amount of stimulation to the liquid.

Thus the target sample can be isolated in units of one molecule by irradiating the liquid flowing through the liquid channel 22b with the infrared laser light from the semiconductor laser 41, detecting the fluorescence from the target sample by the fluorescence detecting element 42 with a very short period of every 10 ms, and further controlling the semiconductor lasers 25b and 25c by the control means based on this detection result to switch the liquid flow to the liquid channel 22b or the liquid channel 22c.

As mentioned above according to this embodiment, the micro-system further comprises: the semiconductor laser 41 being the energy imparting means for imparting the excitation light as energy to the liquid; and the fluorescence detecting element 42 being the change detecting means for detecting the fluorescence of the substance producing the fluorescence by the excitation light from the semiconductor laser 41, wherein the semiconductor lasers 25b and 25c are controlled by the control means based on a signal from the fluorescence detecting element 42. By controlling the liquid flow based on the substance producing the fluorescence by the excitation light from the semiconductor laser 41, it is possible to easily separate only the liquid containing the substance.

The energy guiding path 43 for guiding the excitation light from the semiconductor laser 41 is formed horizontally with the surface of the plate 21. Thus, it is possible to efficiently guide the excitation light from the semiconductor laser 41 to the liquid channel 22a.

By using the fluorescence detecting element 44 or the light receiving element, it is possible to certainly detect the fluorescence of the substance producing the fluorescence by the excitation light from the semiconductor laser 41.

The fluorescence detecting element 44 or the light receiving element is arranged horizontally with the surface of the plate 21. Thus, it is possible to detect the fluorescence of the substance producing the fluorescence by the excitation light from the semiconductor laser 41 from the sides of the liquid channel 22a.

Moreover, the micro-system comprises: the stand 31 for mounting the plate 21; and the semiconductor laser 41 and excitation light detecting element 42a being the positioning means for deciding the position of the plate 21 on the stand 31. By the semiconductor laser 41 and the excitation light detecting element 42a, it is possible to easily mount the plate 21 in the correct position of the stand 31. In particular, when the plate is used as a disposable one, the effort of positioning when mounting the plate 21 correctly can be saved.

### Embodiment 6

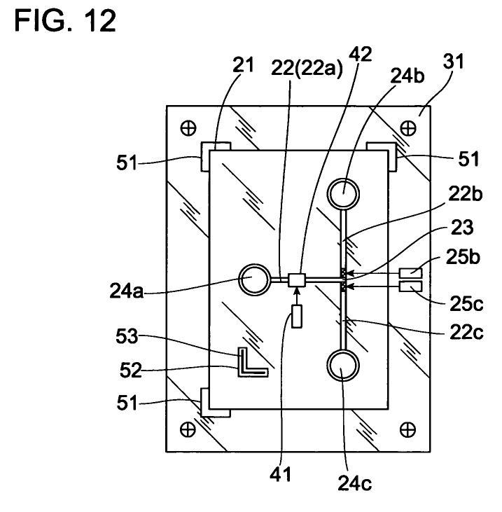

Next a sixth embodiment of the present invention is explained. The same reference symbols are given to the same portions as in the above fifth embodiment, and detailed explanation thereof is omitted. In this embodiment, as shown in FIG. 12, the semiconductor laser 41 is embedded near the liquid channel 22a, and the fluorescence detecting element 44 is arranged above the part irradiated with the excitation light in the liquid channel 22a. Instead of the fluorescence detecting element 44, the fluorescence detecting element may be arranged above the part irradiated with the excitation light in the liquid channel 22a.

Guide components are arranged at three points as the positioning means for fixing the plate 21 in a predetermined position on the stand 31. These guide materials 51 for setting three corners of the plate 21, are formed together with the stand 31. Instead of providing the guide material 51, the micro-system may be configured so as to decide the position of the plate 21 on the stand 31 by making a marking 52 and a marking 53 on the plate 21 and the stand 31 respectively, and aligning the marking 52 with the marking 53. Also the micro-system may be configured so as to decide the direction of the plate 21 as well as the position by using both the guide material 51 and the markings 52 and 53. Furthermore the micro-system may be configured so as to decide the position of the plate 21 on the stand 31 by forming a concave part and a corresponding convex part at the bottom of the plate 21 and on the upper surface of the stand 31 respectively, and fitting the convex part into the concave part.

As mentioned above, according to this embodiment, the fluorescence detecting element 42 or the light receiving element is arranged above the liquid channel 22a. Therefore the fluorescence of the substance producing the fluorescence by the excitation light from the semiconductor laser 41 can be detected from above the liquid channel 22a.

The micro-system, further comprises: the stand 31 for mounting the plate 21; and the guide material 51 being the positioning means for deciding the position of the plate 21 on the stand 31. It is possible to easily mount the plate 21 in the correct position of the stand 31 by the guide material 51. In particular, when the plate is used as a disposable one, the effort of positioning when mounting the plate 21 correctly can be saved.

This invention is not limited to the above embodiment. Many other variations are possible within the scope of this invention. For example, the liquid channel formed on the plate may branch into more than three, or flow together. If necessary, the position and number of stimulation applying means, stimulation detecting means, and change detecting means may be appropriately changed. Moreover, the stimulation applied by the stimulation applying means may be voltage, and a voltage reversible hydro-gel material causing sol-gel transition in proportion to the rise and fall of the voltage may be used. Furthermore, the micro-system may be constructed by combining a plurality of plates.

### Embodiment 7

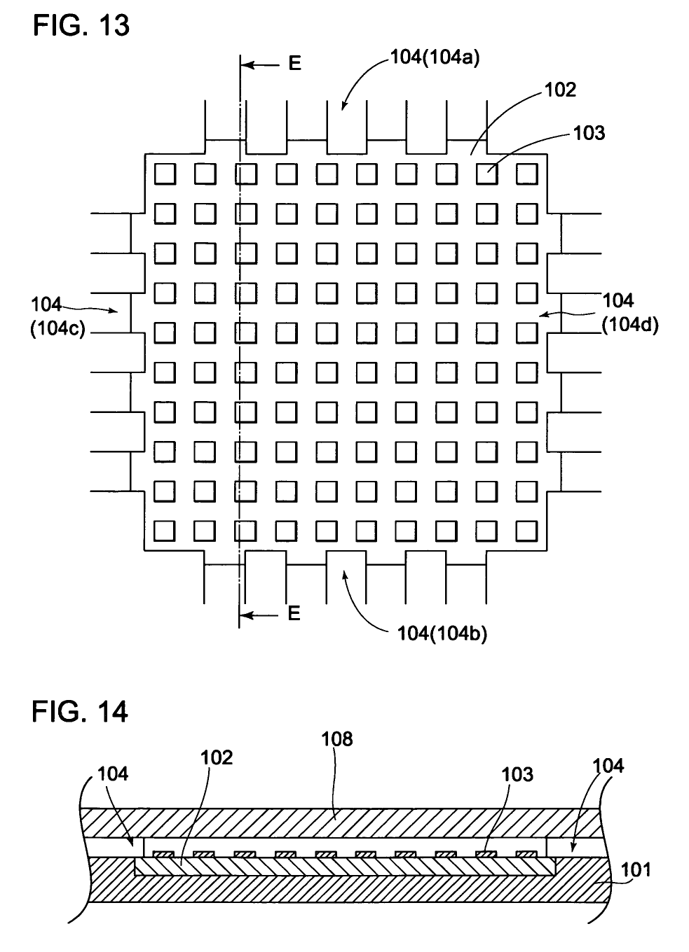

Next, based on FIG. 13 and FIG. 14, a matrix type variable liquid channel being a seventh embodiment of the present invention is explained.

A matrix type variable liquid channel is configured so that metal pieces 103 being the stimulation sensitive members are arranged on a glass plate 102 at an interval of 10 μm in each direction in a pattern of a two dimensional matrix, that is to say, as a two dimensional matrix. The height of the glass plate 102 is 200 μm, the width is 200 μm, and the thickness is 5 μm. The height of the metal pieces 103 is 10 μm, the width is 10 μm, and thickness is 6 nm.

The shape of these stimulation sensitive members is not limited to a flat square, and the shape may be a rectangle, a polygon, or a circular.

The metal pieces 103 being stimulation sensitive members can be formed by a usual method such as a masking method, by vapor deposition, sputtering, chemical vapor deposition (CVD), plating, plasma polymerization, or screen-printing of metal such as titanium, chromium, and the like.

A plurality of external connection channels 104 having a width of 20 μm and a depth of 5 μm are provided on the four sides of the glass plate 102. On two of these sides, four external connection channels 104 are arranged, with inlets 104a facing outlets 104b. On the other two of the four sides, four external connection channels 104 are arranged, with inlets 104c facing outlet 104d.

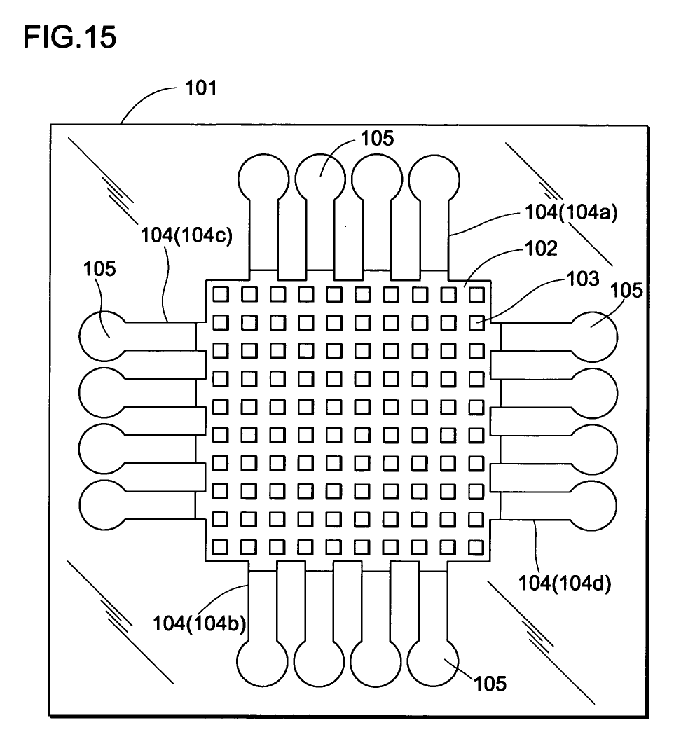

The glass plate 102 (matrix type variable liquid channel) is set in a central part of a basic stand 101, as shown in FIG. 15. The size of this basic stand 101 is about 20 mm on one side. This basic stand 101 consists of glass, silicone, or the like.

The basic stand 101 and the glass plate 102 need not always be separate, and they may be configured so as to be united with each other. For example, as mentioned below, in the case of applying the stimulation to the stimulation sensitive members 103 using light, the stimulation sensitive members 103 may be irradiated with light from a side of the basic stand 101. The basic stand 101 and the glass plate 102 may be configured so as to be united with each other using glass, or the like. On the other hand, when applying the stimulation to the stimulation sensitive members 103 using a switch controller, it is better to construct them so as to be separate from each other, because it is convenient to embed an element such as diode between the basic stand 101 and the glass plate 102.

The external connection channels 104 connected to the glass plate 102 are provided in this basic stand 101. Through passages 105 penetrating the basic stand 101 are formed in the opposite side to the glass plate 102. A solution can be flowed in from the through passages 105 into the external connection channels 104 using a syringe pump not shown in the figure. The solution flowing in the glass plate 102 can be flowed out through the external connection channels 104 to the through passages 105.

There is provided a cover glass 108 on the basic stand 101. The thickness of the cover glass 108 is 100 μm so as to cover the glass plate 102 and the external connection channel 104 completely. Thus the solution in the glass plate flows through an area between the glass plate 102 and the cover glass 108. An interval (height) between this glass plate 102 and the cover glass 108 is preferably 5 to 20 μm.

In FIG. 15, the through passages 105 are provided in the basic stand 101, but the configuration is not particularly limited to this. The through passages 105 may be provided in a position which does not obstruct sample detection, for example on the side of the cover glass 108 or the basic stand 101.

As a method of apply stimulation to the metal pieces 103 being the stimulation sensitive members, the following methods can be used: a method of applying a voltage to the metal piece 103 by a switch controller to heat it; a method of irradiating the metal piece 103 with laser light using a scanner mirror, or an acousto-optic deflector; and a method of irradiating the metal piece 103 with the laser light or lamp light using a digital mirror device.

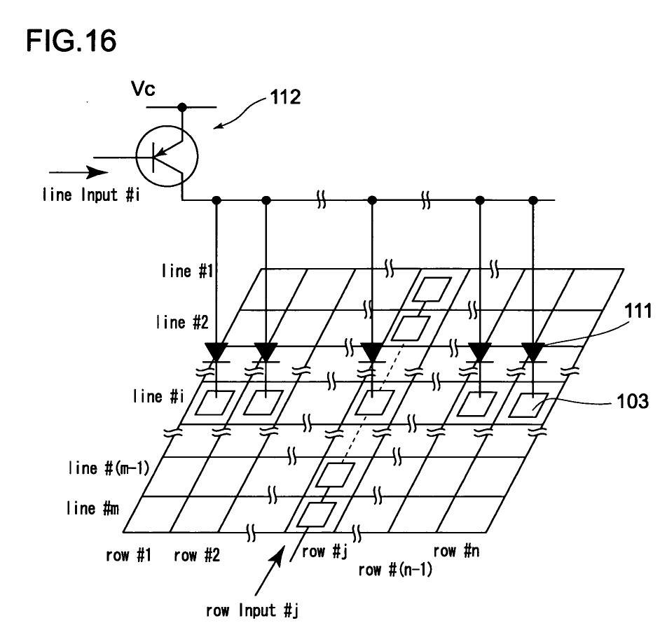

FIG. 16 shows a concept of a method of heating the metal piece 103 by a switch controller. This method involves incorporating a circuit into the glass plate 102, and making the metal piece 103 generate heat by a switching element 112. The circuit consists of a matrix of the metal piece 103 as a resistance body (stimulation sensitive members) and a diode 111.

In FIG. 16, a circuit for line i is shown schematically as an example. Similar circuits are provided from line 1 to line m (m is an arbitrary integer) and from row 1 to row n (n is an arbitrary integer). The metal pieces 103 are formed in the parts where the line intersects with the rows. For example when inputting at line i and row j (for example changing the voltage to Low), the voltage is applied to the metal piece 103 of line i and row j to pass an electric current to generate heat. This input can be controlled by using a computer.

A method of heating the metal piece 103 using light includes the following methods: a method of irradiating the metal piece 10 with laser by using a scanner mirror or an acousto-optic deflector. For example, by using an infrared ray laser such as an Nd:YAG laser (oscillation wave length 1064 nm, 800 mW), the metal piece 103 can be heated by inputting an output from a DA conversion board installed in a computer to the servo driver of the scanner mirror, or, for example, an acousto-optic deflector N45000 made by the NEOS Technologies company, so that a beam moves along the pattern of the passage. In this case, a laser having an oscillation wave length of about 300 nm to about 1600 nm can be used. Especially a semiconductor laser (infrared ray laser) having an oscillation wave length of about 700 nm to about 1600 nm is preferred because it does not prevent detecting a biological sample.

In a method of irradiating the metal piece 103 with a digital mirror device, for example, dual monitors are provided in a computer. A first monitor is used for both output and operation of an image for analyzing the image. A pattern of the liquid channel is outputted to a second monitor by a program for outputting a pattern of the liquid channel. The output from the second monitor is outputted to a digital mirror device as the pattern of the liquid channel. The digital mirror device is located at a position being optically coupled with the matrix type variable liquid channel. The metal piece 103 can be heated by irradiating it with light of a laser or a lamp (mercury lamp or xenon lamp).

Next, wall or valve structures forming the liquid channel are explained.

The solution flows out from the external connection channel 104 into the glass plate 102. For example by including a heat sensitive substance in the solution, and heating the heat sensitive substance for stimulation, the solution can be reversibly turned to a sol or a gel.

As the heat sensitive substance, a heat reversible hydro-gel material can be used. The heat reversible hydro-gel material causes sol-gel transition at 37 degrees C. At less than 37 degrees C. it becomes a sol, and at more than 37 degrees C. it becomes a gel. A material having complete reversibility corresponding to change in temperature is preferred, as the heat reversible hydro-gel material. For example the material disclosed in Japanese Publication Patent No. H05-262882 can be used. A preferred material is for example, methyl-cellulose or Mebiol gel (sol-gel transition temperature approximately 36 degrees C.).

When the temperature for sol-gel transition is too low, it is not preferred because it becomes a gel at room temperature. When too high, it is also not preferred because a sample such as protein contained in the liquid is heat denatured while turning to a gel. The temperature for sol-gel transition may be accordingly changed to the appropriate temperature by choosing the heat reversible hydro-gel material to be used.

Also the type, concentration, etc. of the heat reversible hydro-gel material to be used can be chosen and adjusted so that it may not react with the solution and the sample included in the solution and it may not affect it.

The solution flows in the glass plate 102. By heating the metal piece 103 on the glass plate 102, the heat sensitive substance included in the solution turns to a gel by sol-gel transition. The gel becomes the wall or valve structure forming the liquid channel. The method of heating the metal piece 103 on the glass plate 102 is as follows; a method of heating the metal piece 103 using the above switch controller; a method of irradiating the metal piece 103 with the infrared laser using a scanner mirror, or an acousto-optic deflector; and a method of irradiating the metal piece 103 with light using a digital mirror device.

When there is a demand for forming the liquid channel before the sample material flows in the glass plate 102, the liquid channel can be formed by filling the glass plate 102 with the solution including the heat sensitive substance, and heating the arbitrary metal piece 103 under the above condition.

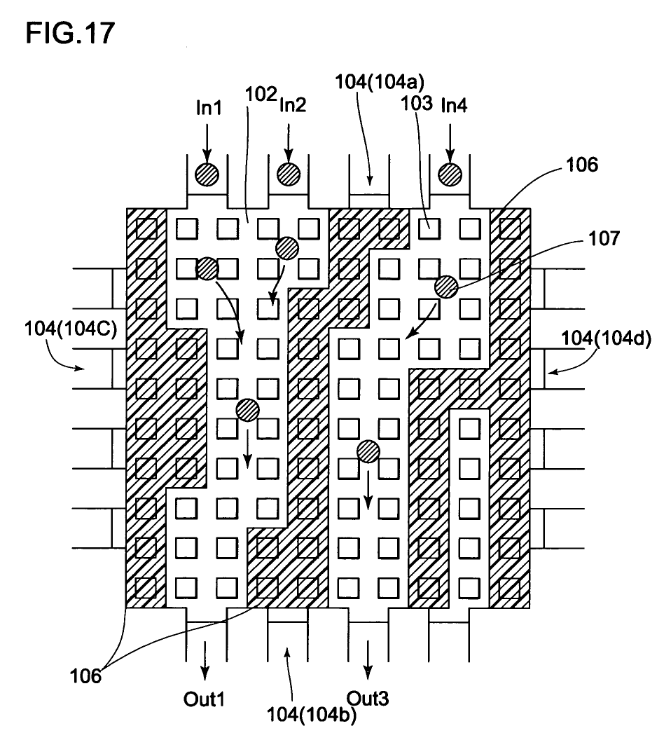

FIG. 17 shows an aspect of where stimulation is given to the glass plate shown in FIG. 13, to gel at an arbitrary position and make a wall or valve structure. The same reference symbols are used for the same parts as in FIG. 13, and the description is omitted.

In FIG. 17, the solution including the heat sensitive substance is flowed in from a first inlet (In1), a second inlet (In2), and a fourth inlet (In4) of the inlet 104a to the glass plate 102, and an arbitrary metal piece 103 is heated by the stimulation applying means such as voltage or light mentioned above. Thus the heat sensitive substance flowing through on the metal piece 103 is turned into a gel to form the wall 106 on the glass plate 102.

In FIG. 17, numeral 107 denotes the sample included in the solution. The arrow at the front edge indicates the flow direction of this sample 107.

In FIG. 17, the sample 107 together with the solution is flowed out to a first outlet (Out1) and a third outlet (Out3) of the outlet to the external connection channel 104.

There are cases where a specific amount of the sample 107 flows out from the first outlet (Out1) and the third outlet (Out3), or where an other sample flows in on the glass plate 102, and so on. In such cases, if necessary, the liquid channel can be changed by turning the wall 106 formed by gellation by the aforementioned stimulation applying means into a sol, and forming the wall or valve structures 106 by applying the stimulation to the metal piece 103 located in a new part to turn it into a gel.

In addition there is a case where the desired sample 107 flows out on the glass plate 102. If the stimulation is applied to the metal piece 103 located surrounding the sample 107, the sample 107 can be made to stay within the glass plate 102. Thus the sample can be analyzed.

As mentioned above, according to this invention, the wall or valve structure can be formed reversibly through the sol-gel transition at any positions by stimulating a plurality of stimulation sensitive members 103 arranged in a pattern of the two dimensional matrix on the glass plate 102. Thus the liquid channel can be easily made. Because channel shape can be freely changed, it is not necessary to prepare liquid channels having different channel shapes.

Moreover, because the stimulation sensitive members 103 are stimulated, the gelation rate of a substance having sol-gel transition properties increases. In addition since there is an interval between the stimulation sensitive members, gelation at any positions is facilitated. Furthermore, by connecting the gelling area, the wall or valve structure 106 can be formed.

The stimulation sensitive members 103 are formed by vapor deposition, sputtering, Chemical Vapor Deposition (CVD), plating, plasma polymerization, or screen-printing, and thus they can be easily formed.

The stimulation sensitive member 103 is stimulated by applying a voltage or irradiating a light thereto. Thus the temperature of the stimulation sensitive member 103 can be adjusted, and the sol-gel transition can be easily initiated.

### Embodiment 8

Next, an eighth embodiment of the present invention is explained.

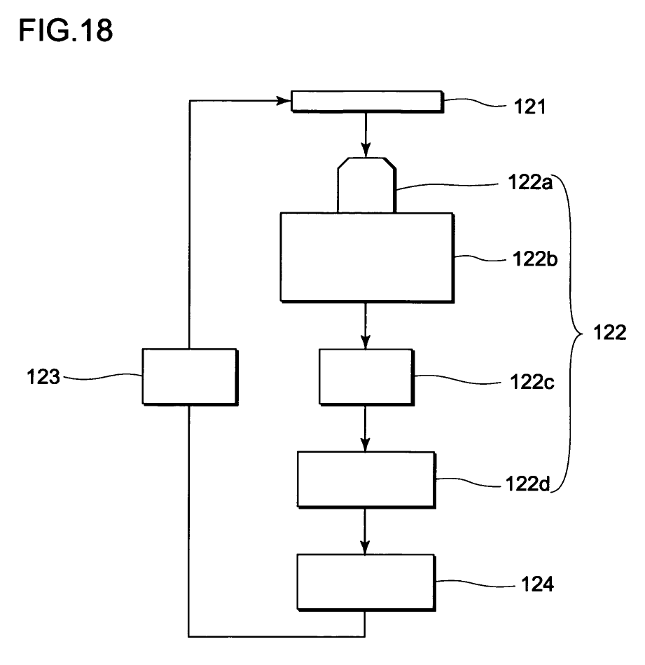

FIG. 18 shows a schematic diagram of a matrix type variable liquid channel system of the present invention.

The matrix type variable liquid channel system comprises: a matrix type variable liquid channel 121 which comprises a plurality of stimulation sensitive members 103 being arranged on the glass plate 102 in a pattern of a two dimensional matrix; a detecting means 122 for detecting a substance on the glass plate 102; a stimulation applying means 123 for applying stimulation to the stimulation sensitive members 103; and a control means 124 for controlling the stimulation applying means 123 based on a signal from the detecting means 122.

For this matrix type variable liquid channel 121, the matrix type variable liquid channel fitted to the basic stand 101 explained in the seventh embodiment of the invention can be used, and hence its explanation is omitted here.

The detecting means 122 for detecting the substance in the matrix type variable liquid channel 121 on the glass plate 102 is provided with a microscope 122b including an object lens 122a, a detecting device 122c and an analyzing device 122d.

General sensors such as a video camera, an avalanche photodiode, or a photoelectron multiplier can be used as the detecting device 122c. An image analyzing device and a device for analyzing the detection result of the general sensors can be used as the analyzing device 122d. In the case of using the video camera as the detecting device 122c, the image analyzing device can be used as the analyzing device 122d. In the case of using the general sensors as the detecting device 122c, the device for analyzing the detection result of the general sensors can be used as the analyzing device 122d.

The stimulation applying means 123 is for applying stimulation to the stimulation sensitive members 103 formed in the matrix type variable liquid channel 121 on the glass plate 102.

As the stimulation applying means 123, the following methods explained in the seventh embodiment can be used; a method of applying a voltage to the stimulation sensitive members 103 by a switch controller to heat it; a method of irradiating the stimulation sensitive members 103 with laser light using a scanner mirror, or an acousto-optic deflector; and a method of irradiating the stimulation sensitive members 103 with the laser light or the lamp light using a digital mirror device. Explanation of these is omitted here.

The control means 124 is for controlling the stimulation applying means 123, based on a signal from the detecting means 122. The control means 124 can control which stimulation sensitive members are irradiated of the stimulation sensitive members formed in the matrix type variable liquid channel 121 on the glass plate 102. The control means 124 can also control the strength, time, etc. of the stimulation.

By means of these configurations, when the solution including the sample and the heat sensitive substance flows in the matrix type variable liquid channel 121 on the glass plate 102, the flow is captured with the object lens 122a. Thereafter, it is guided to an optical microscope 122b, is saved as data in the detecting means 122c connected to the optical microscope 122b, and this data is analyzed using the analyzing device 122d.

Based on the analysis result from this analyzing device 122d, stimulation is applied to the metal pieces 103 being arbitrary stimulation sensitive members on the glass plate 102 by a switch control by the control means 124, so that the stimulation is applied to the metal pieces 103 being the arbitrary stimulation sensitive members on the glass plate 102. This stimulation heats the metal pieces 103, after which the heat sensitive substance turn into a gel through sol-gel transition to form the wall or valve structure 106 on the glass plate 102. Thus the channels can be freely formed.

In the case of using an image analyzing device as the analyzing device 122d, for example, the following images are shown: the image of FIG. 13 showing the liquid channels before the wall or valve structure 106 is formed on the glass plate 102; and the image of FIG. 17 showing the liquid channels formed with the wall or valve structure 106 on the glass plate 102, and the target sample flowing through these channels.

When confirming that target substance flows through the liquid channels, with the analyzing device 122d, the stimulation is applied to the metal piece 103 on the glass plate 102 by the control means 124, and thereafter the heat sensitive substance turn into a gel to form the wall or valve structure 106 at any positions on the glass plate 102. Thus the channels can be changed, and the target sample 107 can be held on the glass plate 102 by surrounding it with the wall 106.

This control is not limited to visual control, and a control means for automatic controlling with a computer or the like may be used.

The sample flowing through the liquid channel, or the sample held on the glass plate 102 may be analyzed with the analyzing device 122d previously loaded with analytical functions, or an analyzing device (not shown) connected to the detecting device 122c.

As mentioned above, according to the embodiment of the present invention, the matrix type variable liquid channel system comprises: the matrix type variable liquid channel 121 which comprises a plurality of stimulation sensitive members 103 arranged on the plate 102 in a pattern of a two dimensional matrix; the detecting means 122 for detecting the substance on the plate 102; the stimulation applying means 123 for applying stimulation to the stimulation sensitive members 103; and the control means 124 for controlling the stimulation applying means 123 based on a signal from the detecting means 122. The wall or valve structure 106 can be formed reversibly through a sol-gel transition at the positions corresponding to the stimulation sensitive member 103, by applying stimulation to it, and thus the liquid channels can be easily made. The liquid channels can be easily formed by controlling the stimulation applying means 123. Thus, it is not necessary to prepare liquid channels having different channel shapes. In addition the substance can be detected at any positions on the plate 102, and hence the desired sample substance is easily separated or analyzed.

The stimulation is applied to the stimulation sensitive member 103, and hence the gelation rate of the substance having sol-gel transition properties increases. There is an interval between the stimulation sensitive members, and hence it is easier to turn it into a gel at any position.

Because the wall or valve structure 106 can be formed by connecting the gelling area, the liquid channels can be easily changed on the glass plate 102, and the target sample can be easily separated or analyzed.

Moreover, because the stimulation sensitive members are formed by vapor deposition, sputtering, Chemical Vapor Deposition (CVD), plating, plasma polymerization, or screen-printing, they can be easily formed. Thus the matrix type variable liquid channel system can be made cheaply.

The means for applying a voltage or irradiating a light thereto is used as the stimulation applying means 123. Thus, the stimulation can be easily applied to the stimulation sensitive members 103, the temperature of the stimulation sensitive members 103 can be adjusted, and the sol-gel transition can be easily initiated.

Moreover, by such a construction, the liquid channels on the plate can be easily changed, and hence the substance can be detected at any position on the plate, and the target sample can be easily separated or analyzed.

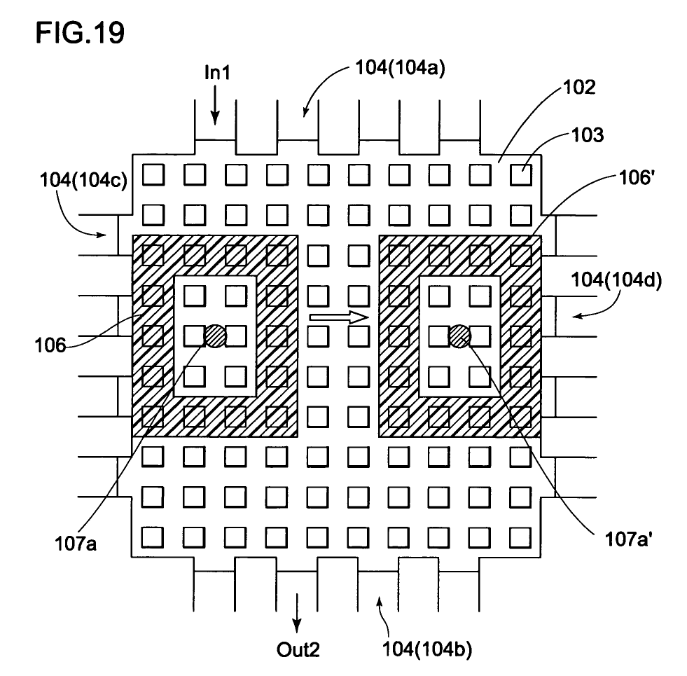

Next, application examples 1 to 4 in this invention are explained using FIG. 19 to 26. In the application examples, the same reference symbols denote the same portion as in the above seventh embodiment and eighth embodiment, and the detailed explanation is omitted. Moreover, because the configuration of the matrix type variable liquid channel system is the same as the one in the eighth embodiment, its drawing is not especially shown, and its explanation is omitted.

### APPLICATION EXAMPLE 1

FIG. 19 is a schematic diagram showing that a sample 107a is surrounded with a gelled wall 106, and is moved and secured.

First, in FIG. 19, the solution including a heat sensitive substance and the sample 107a is flowed in from an inlet (In1) shown at the top of FIG. 17 to the glass plate 102, and the solution is flowed out from an outlet (Out1) shown at the bottom of FIG. 19. Then the liquid channels are formed by stimulating the metal pieces 103 being heat sensitive substances to turn the heat sensitive substance into a gel (the liquid channel in which the solution flows is not shown in FIG. 19).

When the sample 107a flowing in this liquid channel is detected by the detecting means 122, the metal pieces 103 are irradiated with the laser to form the gelled wall 106 caused by the heat sensitive substance so as to surround the sample 107a. Next, as indicated by the arrow, the sample 107a surrounded with the wall 106 is moved to an area where heaters (not shown) are located in the glass plate 102. Thereafter the sample 107a′ is fixed, being surrounded with the wall 106′.

The sample 107a is moved as follows: first the metal piece just to the right of the metal piece causing the gelled wall 106 is gelled, and then the gelled wall 106 to its left is turned into a sol. Thus the entire wall can be moved by one metal piece. By repeating this many times, the sample 107a can be moved to an area where heaters are located in the glass plate 102, while the sample 107 is surrounded with the wall 106a. Then a thermal change of the sample 107a′ can be observed by heating the sample 107a′ using the heaters. Various biological samples such as a cell, organelle, nucleic acid, protein can be used as the sample.

### APPLICATION EXAMPLE 2

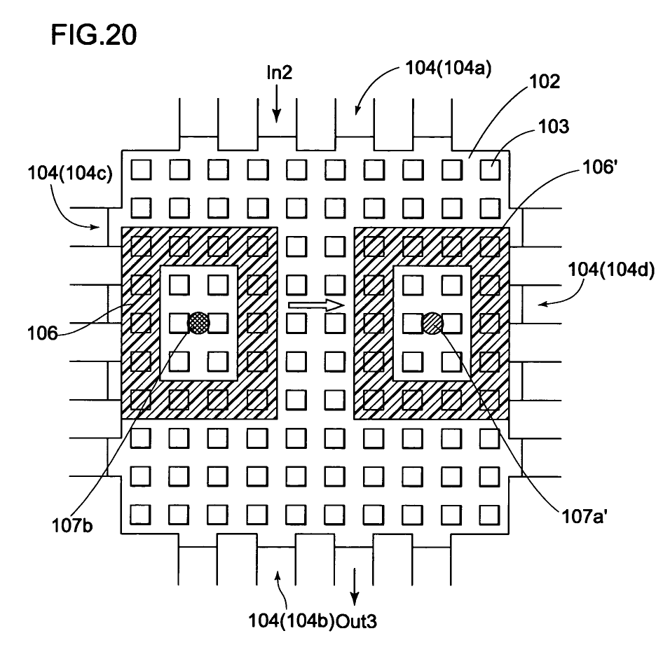

By the same method as the application example 1, as shown in FIG. 20, the first sample 107a′ is surrounded with the gelled wall 106′, and fixed at the area where heaters (not shown) are located.

Next, as shown in FIG. 20, the solution including a heat sensitive substance and the sample 107b is flowed in from an inlet (In2) shown at the top of FIG. 20 to the glass plate 102, and the solution is flowed out from an outlet (Out2) shown at the bottom of FIG. 20. The liquid channels are formed by stimulating the metal pieces 103 to turn the heat sensitive substance into a gel (the liquid channel in which the solution flows is not shown in FIG. 20). Thereafter a second sample 107b is surrounded with the gelled wall 106 by the same method as application example 1.

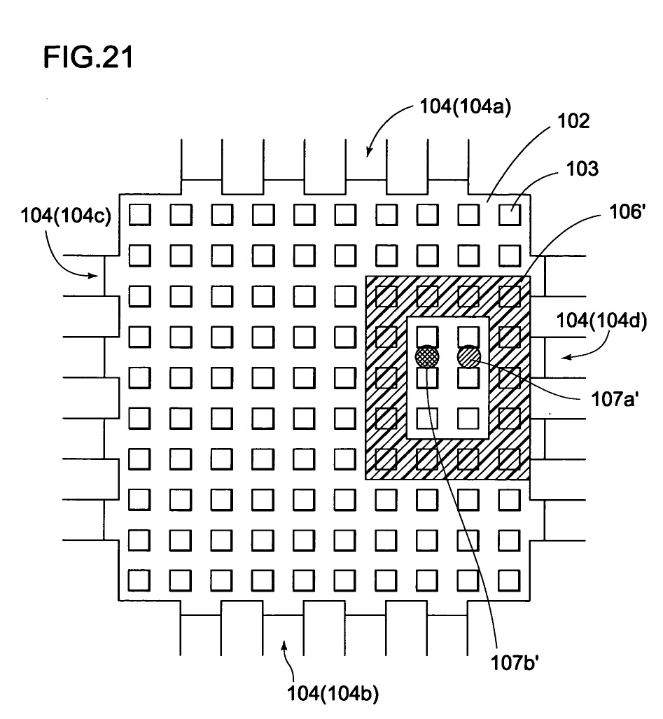

The second sample 107b is moved to the place of the wall 106′ where the first sample 107a′ is fixed. Then a part of the gelled walls 106 and 106′ are each opened to put the first sample 107a′ and the second sample 107b′ inside the same walls. Thereafter, as shown in FIG. 21, the wall size is changed so that the first sample 107a′ may react with the second sample 107b′. Then, the first sample 107a′ is contacted with the second sample 107b′ to chemically react them by using heat from a heater, electric field, or the like.

For the sample, various biological samples and agents such as a cell, organelle, nucleic acid, protein can be used to analyze their interaction or chemical reaction.

### APPLICATION EXAMPLE 3

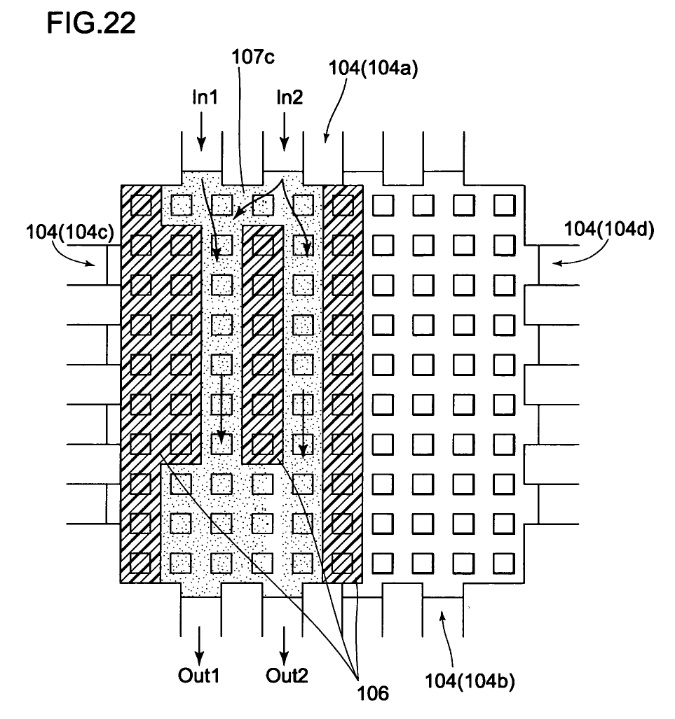

FIGS. 22 to 24 are schematic diagrams showing a condition where a certain amount of sample is collected and moved to an analyzing system, or the like.

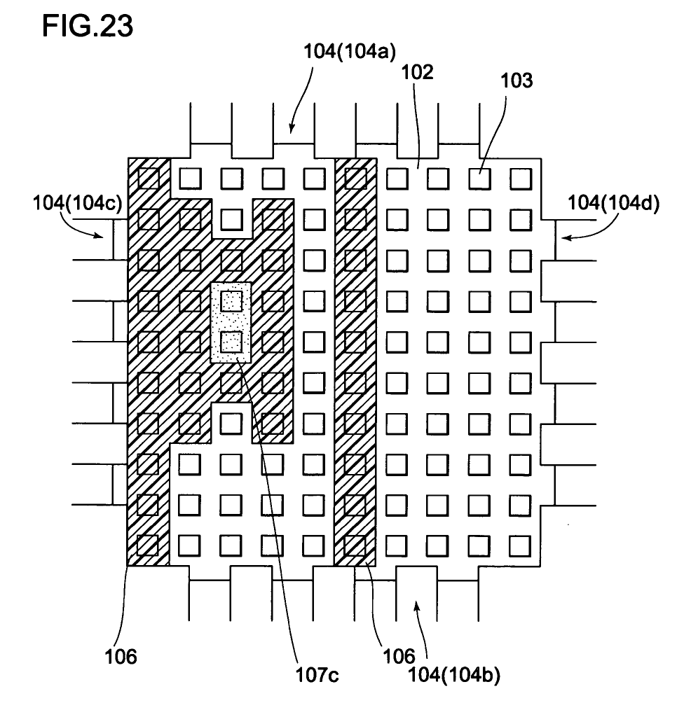

The solution including the heat sensitive substance is flowed in from inlets (In1, In2) at the top of the FIG. 22 to the glass plate 102, and the liquid channels are formed by irradiating arbitrary metal pieces 103 being the stimulation sensitive members with a laser. Next the solution mixed with the heat sensitive substance and the sample 107c is flowed in from the inlets (In1, In2) at the top of the FIG. 22 to the glass plate 102. The solution flows through a predetermined channel, and flows out from the outlets (Out1, Out2) at the bottom of FIG. 22. After confirmation of the state that the solution is flowing through the channels using a detecting means 122, the metal pieces 103 at the side of the inlets and the outlets in the channel are irradiated with the laser to turn the heat sensitive substance into a gel, after which inflow of the solution is stopped. FIG. 23 shows this condition. Thus, a certain amount of sample 107c can be held in the glass plate 102.

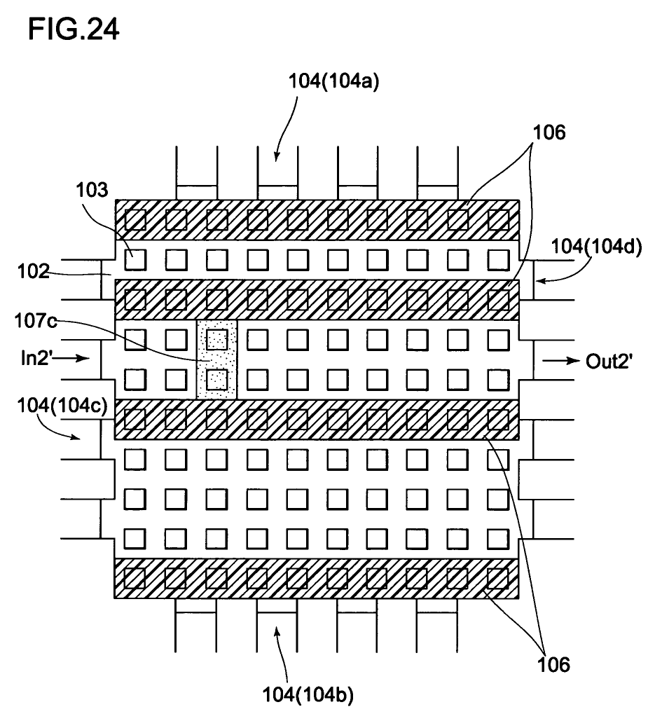

Next, as shown in FIG. 24, in order to flow a carrier solution from an inlet (In2′) shown at the left-hand side of FIG. 24 to the plate 102, and transfer the carrier solution through an outlet (Out2′) at the right-hand side of FIG. 24 to the analyzing device, the metal pieces 103 are irradiated with the laser to turn the heat sensitive substance into the gel, and thereafter the carrier solution is flowed in from the inlet (In2′). Thus, a certain amount of the sample 107c can be transferred from the outlet (Out2′) to the analyzing device.

### APPLICATION EXAMPLE 4

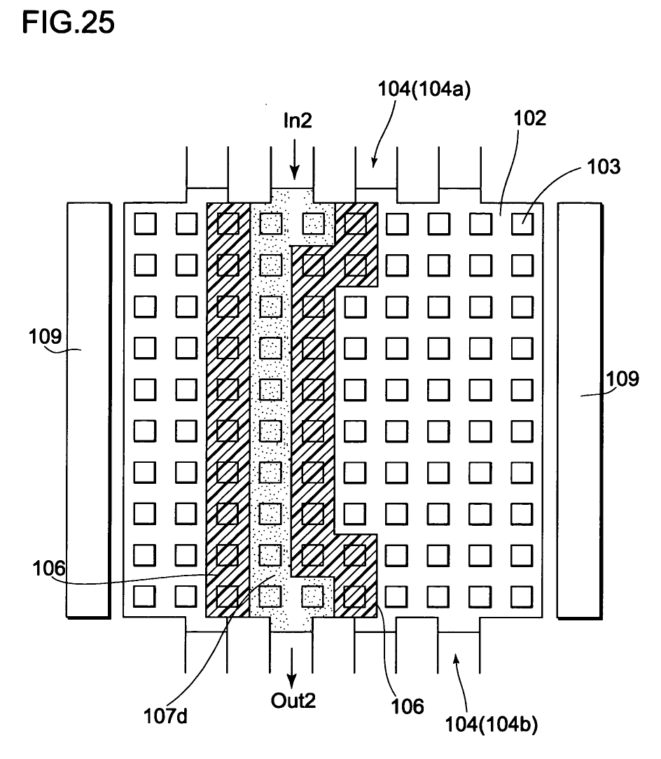

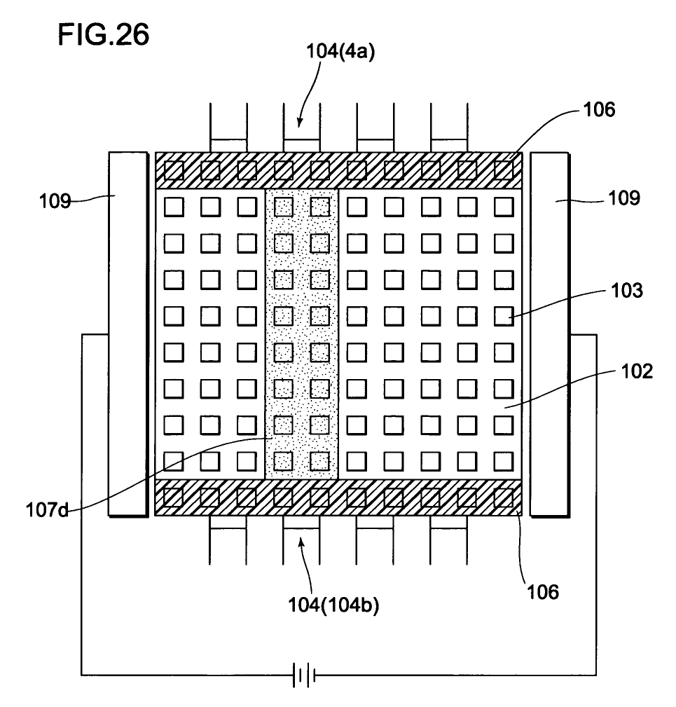

FIGS. 25 and 26 are schematic diagrams showing molecule separation by electrocataphoresis.

In FIG. 25, instead of a pair of the inlet 104c at the left side of FIG. 13 and the outlet 104d at the right side of FIG. 13, a pair of electrodes 109 and 109 are provided so as to sandwich the glass plate 102 therebetween. The solution including the heat sensitive substance is flowed in from an inlet (In2) at the top of FIG. 25 to the glass plate 102. The solution is flowed out from an outlet (Out2) at the bottom of FIG. 25. To do this, the liquid channel is formed by irradiating the metal pieces 103 being stimulation sensitive members with the laser to turn the heat sensitive substance into the gel. Thereafter when the solution mixed with the heat sensitive substance and a sample 107d is flowed in from the inlet at the top of FIG. 25 to the glass plate 102, the solution flows through a predetermined channel.

After confirmation of the state that the solution is flowing through the channel, using the detecting means 122, the metal pieces 103 around the inlet and the metal pieces 103 around the outlet are irradiated with the laser to turn the heat sensitive substance into a gel. Thus the solution does not flow on the glass plate 102. FIG. 26 shows this state.

Thereafter, by impressing an electric filed to the pair of electrodes 109 in this state, molecule separation of sample 107d can be performed by electrophoresis.

### Embodiment 9

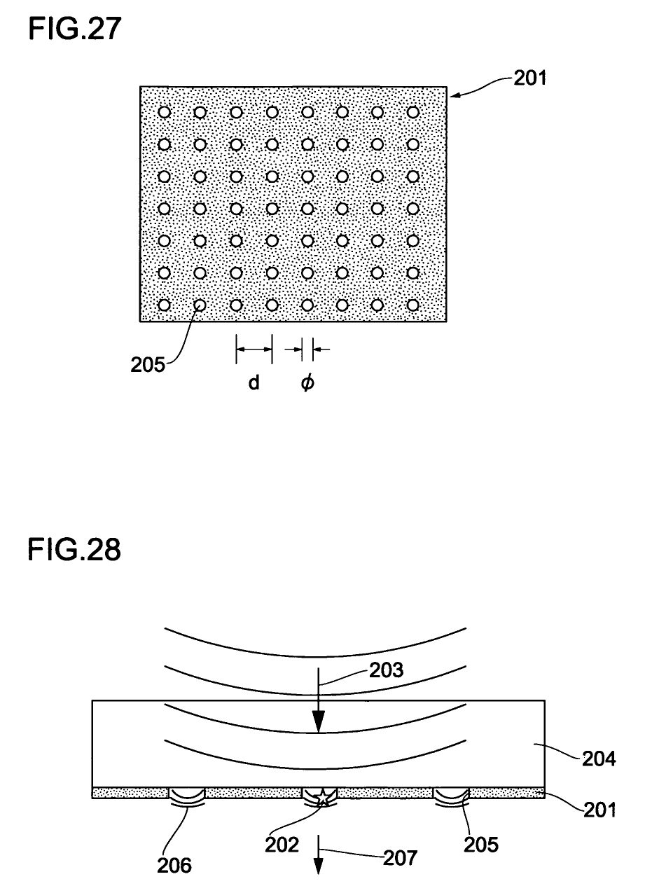

Hereafter, based on FIG. 27 and FIG. 28, an explanation will be given of a nano-aperture film according to a ninth embodiment of the present invention. Numeral 201 denotes a nano-aperture film (i.e. a film with a nano-aperture). The nano-aperture film 201 is composed of a thin film that does not transmit excitation light 203 which excites a fluorescent biomolecule 202 labeled with fluorescent dye, the fluorescent biomolecule 202 being the analysis object. The nano-aperture film 201 is combined with a transparent plate 204 made from a material such as a glass and the nano-aperture film 201 has the thin film formed on the plate 204, the thin film being made from a material such as a metal (e.g. aluminum, chromium, gold, silver, or germanium), or silicon carbide (SiC) by using a technique such as vapor deposition.

The nano-aperture film 201 is formed with a plurality of nano-apertures 205, wherein the nano-apertures 205 are arranged at equal intervals of each interval d in an anteroposterior and horizontal direction. The nano-apertures 205 are formed in a circle of diameter Φ. It should be noted that the nano-apertures 205 do not necessarily need to be in a circle. When the nano-apertures 205 are not in a circle, the diameter Φ is set to the maximum opening width of the nano-apertures 205.

Moreover, the diameter Φ of the nano-aperture 205 is smaller than the wavelength λex of the excitation light 203. The diameter Φ is preferable as small as possible. That is, the smaller the diameter Φ is reduced the smaller the region of an evanescent field 206 hereinafter described, which is advantageous for exciting the fluorescent biomolecule 202 at the level of a single molecule. Therefore, it is desirable that the diameter Φ is 200 nm or less, and more preferably 20 nm or less.

Moreover, in order to detect the fluorescence which the fluorescent biomolecule 202 emits at the level of a single molecule, the interval d between the nano-apertures 205 is made the same as or greater than the resolution of an objective lens 213 of an optical microscope, which constitutes a fluorescence detecting means 212 (hereinafter described), for detecting a fluorescence 207 of the fluorescent biomolecule 202. That is, when the detected light is not coherent, the resolution of the objective lens 213 is defined by the formula: 0.61 λem/NA, wherein λem is the wavelength of the fluorescence 207, and NA is the numerical aperture of the objective lens 213. Therefore, the interval d between the nano-apertures 205 satisfies for the formula: d>0.61 λem/NA. For example, when the wavelength λem of the fluorescence 207 is 500 nm, the resolution of the objective lens 213 is 0.61 λem/NA≈250 nm assuming the numerical aperture (NA) of the objective lens 213 is set to a value of 1.2. Therefore, when the objective lens 213 whose the numerical aperture (NA) is 1.2 is used, the fluorescence which the fluorescent biomolecule 202 emits can be detected at the level of a single molecule by using the nano-aperture film 201 with the nano-apertures 205, wherein the interval d between the nano-apertures 205 is 250 nm or more.

Next, the operation is described. As shown in FIG. 28, when the excitation light 203 is incident from the side of the plate 204 on which the nano-aperture film 201 is not combined, excitation light 203 leaks out from the nano-apertures 205, namely, an evanescent field 206 is generated. The size of this evanescent field 206 is comparable to the size of the nano-apertures 205, and is capable of exciting fluorescent biomolecules 202 residing in a region smaller than the wavelength λex of the excitation light 203 near the nano-apertures 205 and emitting fluorescence 207. Moreover, the plurality of nano-apertures 205 are spaced at more than the resolution of the objective lens 213 of the optical microscope, so that it is possible to isolate the fluorescence 207 of each fluorescent biomolecule 202 excited through each nano-aperture 205, and to measure one molecule.

In addition, since the evanescent field 206 is attenuated over about 150 nm of penetration length, the region of the evanescent field 206 is proportional to the area of the nano-aperture 205. Therefore, when the fluorescent biomolecule 202 is excited in the conventional way using the evanescent field due to the total reflection of the interface without allowing it to pass through the nano-aperture film 201, in order to detect the fluorescent biomolecule 202 at the level of a single molecule, the concentration of the fluorescent biomolecule 202 needs to be set to 50 nM or less so that only one molecule exists within a diameter of 250 nm, which is the resolution of the objective lens 213. However, by using the nano-aperture film 201 of this invention, when the diameter of the nano-aperture 205 is 100 nm, the concentration of the fluorescent biomolecule 202 may be made to increase to about 300 nM. Furthermore, when the diameter of the nano-aperture 205 is 20 nm, the concentration of the fluorescent biomolecule 202 may be made to increase to about 8000 nM. That is, the concentration of the fluorescent biomolecule 202 may be made to increase to 100 to 1000 times in comparison to the conventional concentration. Therefore, it is possible to decrease exponentially the adverse effects where biomolecules are absorbed nonspecifically to the surface of the glass, or the like.

As mentioned above, the nano-aperture film 201 in the above-mentioned embodiment is provided with nano-apertures 205, and comprised of a thin film which does not transmit light. Therefore, when the maximum opening width Φ of the nano-apertures 205 is made smaller than the wavelength λex of the excitation light 203, and these nano-apertures 205 are irradiated with the excitation light 203, the evanescent field 206 is generated through these nano-apertures 205 so that the fluorescent biomolecule 202 in a region smaller than the wavelength λex of the excitation light 203 can be irradiated with the excitation light 203 by using the evanescent field 206.

Moreover, since the nano-aperture film 201 being the thin film is combined with the transparent plate 204, the manufacturing and handling of the nano-aperture film 201 can be improved by supporting the nano-aperture film 201 on the plate 204. Moreover, since the plate 204 is transparent, it does not prevent the transmission of excitation light 203.

Furthermore, a plurality of nano-apertures 205 are provided and arranged at substantially equal intervals, so that the fluorescence 207 of the fluorescent biomolecule 202 is observable in the arbitrary nano-apertures 205 of a plurality of nano-apertures 205. Thus alignment by a fluorescence detecting means is easy. Moreover, when the interval d between the nano-apertures 205 is the same as the resolution of the fluorescence detecting means, or larger than the resolution of the fluorescence detecting means, the fluorescence 207 of each fluorescent biomolecule 202 excited by each nano-aperture 205 can be separated, and the interaction between biomolecules can be detected at the level of a single molecule.

Furthermore, since the diameter Φ being the maximum opening width of the nano-aperture 205 is 200 nm or less, the diameter Φ of the nano-aperture 205 can be made smaller than the wavelength λex of the excitation light 203.

### Embodiment 10

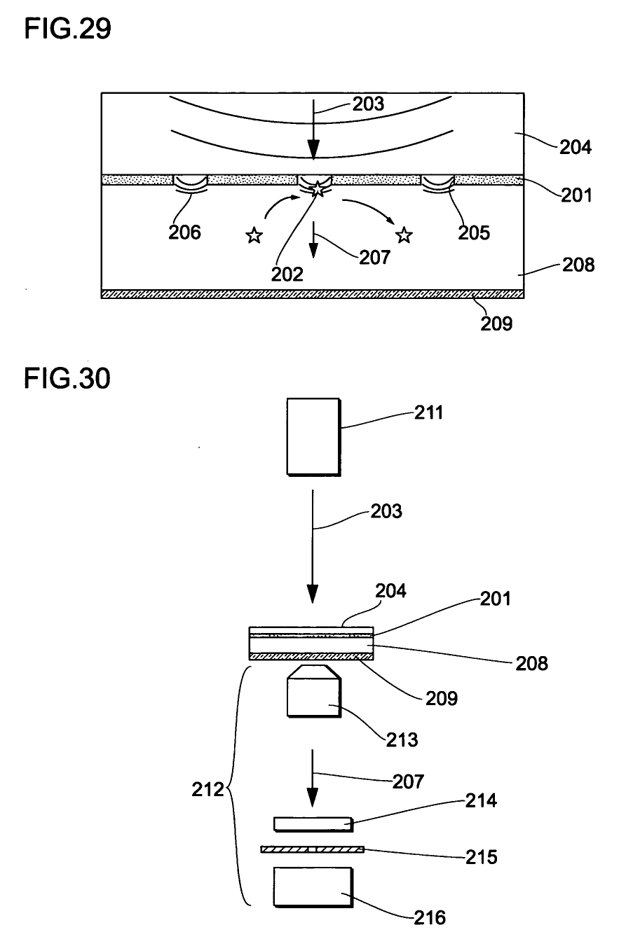

Next, a device for analyzing a biomolecular interaction according to a tenth embodiment of the present invention will be explained with reference to FIG. 29 and FIG. 30. This device for analyzing a biomolecular interaction is equipment for analyzing the intensity of the fluorescence 207 which the fluorescent biomolecule 202 emits, or the diffusion coefficient of the fluorescent biomolecule 202, by fluorescence correlation spectroscopy (FCS) using a nano-aperture film 201. Here the construction of the nano-aperture film 201 is similar to that of the above-mentioned embodiment, and the same reference numerals are used, and detailed description is omitted.

Numeral 211 denotes a laser being an excitation light generating means for generating an excitation light. A lamp instead of the laser 211 may be used. This laser 211 is configured so that the nano-aperture film 201 is irradiated with the excitation light 203 for the fluorescent biomolecule 202. An aqueous solution 208 including the fluorescent biomolecule 202 is held between a side where the plate 204 is combined with the nano-aperture film 201, and a cover glass 209, and the construction is such that the excitation light 203 irradiates from the side where the plate 204 is not combined with the nano-aperture film 201.

The outside of the cover glass 209 is provided with a fluorescence detecting means 212 for detecting the fluorescence 207 emitted from the fluorescent biomolecule 202. This fluorescence detecting means 212 is provided with an objective lens 213 of a microscope (not shown), an optical filter 214, a pinhole 215, and a detector 216. The objective lens 213 is arranged so as to gather the fluorescence 207 emitted from the fluorescent biomolecule 202. The optical filter 214 is arranged so as to remove a background light such as dispersion light and to pass only the fluorescence 207. Moreover, the pinhole 215 is arranged so as to detect the fluorescence 207 from the single nano-aperture 205, and a pore size of the pinhole 215 is approximately the resolution of the objective lens 213× the magnification of the objective lens 213. The resolution of the objective lens 213 is defined by the formula: 0.61 λm/NA for a numerical aperture (NA) of the objective lens 213 as above-mentioned. It is configured so that the fluorescence 207 passing through the pinhole 215 is detected with a high-sensitivity detector 216, and then a detection signal thereof is processed with a digital counter, a digital correlation machine, or the like so as to analyze according to the technique of the conventional FCS.

Next, an analysis method by using the above-mentioned device for analyzing a biomolecular interaction will be explained. Firstly, the aqueous solution 208 including the fluorescent biomolecule 202 is added between the nano-aperture film 201 and the cover glass 209, and mounted on a microscope. The excitation light 203 is incident from the back side of the nano-aperture 205, and generates the evanescent field 206. When the fluorescent biomolecule 202 passes through the evanescent field 206, the fluorescence 207 is emitted. The fluorescence 207 is gathered with the objective lens 213, the background light such as dispersion light is removed with the optical filter 214, and only the fluorescence 207 is passed. Then, the fluorescence 207 which had passed through the optical filter 214 is passed through the pinhole 215, and only the fluorescence 207 from a single nano-aperture 205 is detected by the detector 216. Then a detection signal thereof is processed with a digital counter, a digital correlation machine, or the like, and is analyzed according to the technique of the conventional FCS.

As is apparent from the above, a device for analyzing a biomolecular interaction according to the aforementioned embodiment comprises: the laser 211 being the excitation light generating means for generating the excitation light 203; the nano-aperture film 201 which comprises a thin film which does not transmit light, and in which the nano-apertures 205 are formed, wherein a diameter Φ being a maximum opening width of the nano-aperture is smaller than the wavelength λex of the excitation light 203; and the fluorescence detecting means 212 for detecting the fluorescence 207. When the nano-aperture film 201 with the nano-apertures 205, the diameter Φ of which is smaller than the wavelength λex of the excitation light 203, is irradiated with the excitation light 203 from the laser 211, the evanescent field 206 is generated in the nano-apertures 205. Therefore, by using the evanescent field 206, the fluorescent biomolecule 202 can be irradiated with the excitation light 203 in an area smaller than the wavelength λex of the excitation light 203, and the fluorescence 207 emitted from the fluorescent biomolecule 202 is able to be detected with the fluorescence detecting means 212. Moreover, by irradiating the fluorescent biomolecule 202 with the excitation light 203 in an area smaller than the wavelength λex of the excitation light 203, the concentration in the solution 208 including the fluorescent biomolecule 202 can be increased. Furthermore, the influence of the nonspecific absorption of the fluorescent biomolecule 202 in the surface of the plate 204 being a glass surface, can be prevented. Thus detection or determination of the biomolecular interaction can be performed reliably.

Moreover, a plurality of nano-apertures 205 are provided and arranged at equal intervals, and the interval d between the nano-apertures 205 is the same as the resolution of the objective lens 213 of the fluorescence detecting means 212, or larger than the resolution of the objective lens 213. Therefore that the fluorescence 207 of the fluorescent biomolecule 202 is observable in arbitrary nano-apertures 205 of a plurality of nano-apertures 205, and hence alignment by a fluorescence detecting means is facilitated. Moreover, since the interval d between the nano-apertures 205 is the same as the resolution of the objective lens 213 of the fluorescence detecting means 212, or larger than the resolution of the objective lens 213, the fluorescence 207 of each fluorescent biomolecule 202 excited by each nano-aperture 205 can be separated, and the interaction between biomolecules can be detected at the level of a single molecule.

Furthermore, a method of analyzing a biomolecular interaction according to the foregoing embodiment comprises the steps of: generating an evanescent field 206 by the excitation light 203 from the nano-apertures 205 smaller than a wavelength λex of the excitation light 203; exciting a fluorescent biomolecule 202 which passes through a certain region of the evanescent field 206 by Brownian motion; and detecting the fluorescence 207 of the fluorescent biomolecule 202. Hence, the fluorescent biomolecule 202 can be irradiated with the excitation light 203 in an area smaller than the wavelength λex of the excitation light 203, and the interaction between biomolecules can be detected at the level of a single molecule.

### Embodiment 11

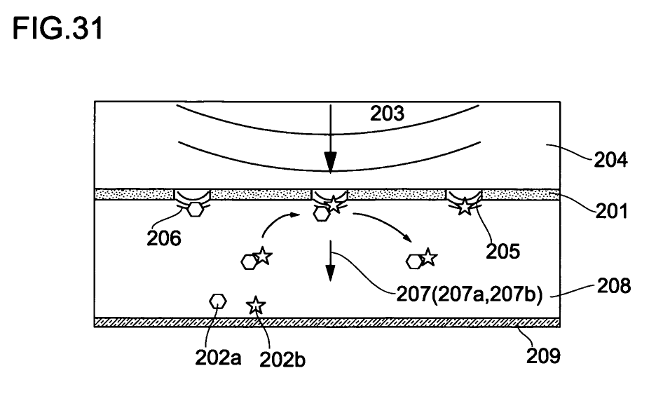

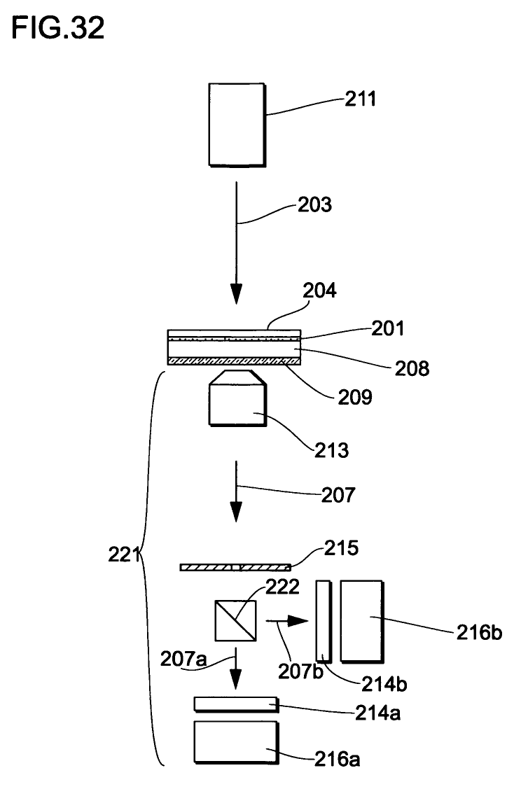

Next, a device for analyzing a biomolecular interaction according to an eleventh embodiment of the present invention will be explained with reference to FIG. 31 and FIG. 32. This device for analyzing a biomolecular interaction is equipment for detecting the biomolecular interaction of fluorescent biomolecules 202a and 202b from fluorescence 207 (207a, 207b) which the fluorescent biomolecules 202a and 202b labeled with fluorescence molecules having different fluorescence wavelengths emit, by fluorescence cross-correlation spectroscopy (FCCS), using the nano-aperture film 201. The same portions as those described in the above-mentioned embodiment are designated by the same reference numerals, and their detailed description is omitted.

Numeral 211 denotes a laser being an excitation light generating means for generating an excitation light. A lamp instead of the laser 211 may be used. This laser 211 is configured so that the nano-aperture film 201 is irradiated with the excitation light 203 being common to two kinds of fluorescent biomolecules 202a and 202b. An aqueous solution 208 including the fluorescent biomolecules 202a and 202b is held between a side where the plate 204 is combined with the nano-aperture film 201, and a cover glass 209, and the construction is such that the excitation light 203 irradiates from the side where the plate 204 is not combined with the nano-aperture film 201.

The outside of the cover glass 209 is provided with a fluorescence detecting means 221 for detecting the fluorescence 207 (207a, 207b) emitted from the fluorescent biomolecules 202a and 202b. This fluorescence detecting means 221 is provided with an objective lens 213 of a microscope (not shown), a pinhole 215, a dichroic mirror 222, optical filters 214a, 214b, and detectors 216a, 216b. The objective lens 213 is arranged so as to gather the fluorescence 207 (207a, 207b) emitted from the fluorescent biomolecules 202a and 202b. The pinhole 215 is arranged so as to detect the fluorescence 207 (207a, 207b) through the single nano-aperture 205 among the fluorescence 207 gathered with the objective lens 213. Moreover, a pore size of the pinhole 215 is approximately the resolution of the objective lens 213× the magnification of the objective lens 213. The resolution of the objective lens 213 is defined by the formula: 0.61 λem/NA for a numerical aperture (NA) of the objective lens 213 as above-mentioned.

The dichroic mirror 222 is used to transmit only a specific wavelength region and reflect other regions. The dichroic mirror 222 is arranged here so as to transmit the fluorescence 207a emitted from the fluorescent biomolecule 202a among the fluorescence 207 which passes through the pinhole 215, and reflect the fluorescence 207b emitted from the fluorescent biomolecule 202b. Moreover, optical filters 214a and 214b are arranged so as to remove background light such as dispersion light among the light containing the fluorescences 207a and 207b transmitted and reflected by the dichroic mirror 222, and pass only fluorescences 207a and 207b, respectively. Then, the invention according to this embodiment comprises the steps of: detecting the fluorescences 207a, 207b which have passed through the optical filters 214a and 214b, with the high-sensitivity detectors 216a and 216b, respectively; processing a detection signal thereof with a digital counter or a digital correlation machine, or the like; cross-correlating fluorescences 207a and 207b according to the technique of the conventional FCCS; and detecting the association of the fluorescent biomolecule 202a and the fluorescent biomolecule 202b.

Next, an analysis method by using the above-mentioned device for analyzing a biomolecular interaction will be explained. Firstly, the aqueous solution 208 including the fluorescent biomolecules 202a and 202b is added between the nano-aperture film 201 and the cover glass 209, and mounted on a microscope. The excitation light 203 is incident from the back side of the nano-aperture 205, and generates the evanescent field 206. When the fluorescent biomolecules 202a and 202b pass through the evanescent field 206, the fluorescent biomolecules 202a and 202b are excited, and then the fluorescences 207a and 207b are emitted, respectively. The fluorescences 207a and 207b are gathered with the objective lens 213, and their lights are passed through the pinhole 215 so as to pass only the fluorescence 207a and 207b from the single nano-aperture 205. Then, the fluorescence 207a and 207b which had passed the pinhole 215 is separated with a dichroic mirror 222. That is, the fluorescence 207a is transmitted through the dichroic mirror 222, and the fluorescence 207b is reflected by the dichroic mirror 222. In addition, as for the fluorescences 207a and 207b separated by the dichroic mirror 222, background light such as dispersion light is removed by the optical filters 214a and 214b, respectively. Then, the fluorescences 207a and 207b which have passed through the optical filters 214a and 214b are detected by the detectors 216a and 216b, respectively.

As shown in the center nano-aperture 205 in FIG. 31, when the fluorescent biomolecule 202a and the fluorescent biomolecule 202b bind together, the fluorescences 207a and 207b of the fluorescent biomolecules 202a and 202b are observed simultaneously. On the other hand, as shown in the nano-apertures 205 of the opposite ends in FIG. 31, when the two fluorescent biomolecules 202a and 202b are not bound together, only one fluorescence 207 (the fluorescence 207a or fluorescence 207b) is detected. The detection signal thereof is processed with a digital counter, a digital correlation machine, or the like, and cross-correlation of the fluorescences 207a and 207b according to the technique of the conventional FCCS is made so as to detect the association of the fluorescent biomolecule 202a and the fluorescent biomolecule 202b.

As explained above, a device for analyzing a biomolecular interaction according to the foregoing embodiment comprises: the laser 211 being the excitation light generating means for generating the excitation light 203; the nano-aperture film 201 which comprises a thin film which does not transmit light, and in which the nano-apertures 205 are formed, wherein a diameter Φ being a maximum opening width of the nano-aperture is smaller than the wavelength λex of the excitation light 203; and the fluorescence detecting means 221 for detecting the fluorescence 207 (207a, 207b). When the nano-aperture film 201 with the nano-apertures 205, the diameter Φ of which is smaller than the wavelength λex of the excitation light 203, is irradiated with the excitation light 203 from the laser 211, the evanescent field 206 is generated in the nano-apertures 205. Therefore, by using the evanescent field 206, the fluorescent biomolecules 202a and 202b can be irradiated with the excitation light 203 in an area smaller than the wavelength λex of the excitation light 203, and the fluorescences 207a and 207b emitted from the fluorescent biomolecules 202a and 202b is able to be detected with the fluorescence detecting means 221. Moreover, by irradiating the fluorescent biomolecules 202a and 202b with the excitation light 203 in an area smaller than the wavelength λex of the excitation light 203, the concentration in the solution 208 including the fluorescent biomolecules 202a and 202b can be increased. Furthermore, the influence of the nonspecific absorption of the fluorescent biomolecules 202a and 202b in the surface of the plate 204 being a glass surface, can to be prevented. Thus detection or determination of the biomolecular interaction can be performed reliably.

Moreover, a plurality of nano-apertures 205 are provided and arranged at equal intervals, and the interval d between the nano-apertures 205 is the same as the resolution of the objective lens 213 of the fluorescence detecting means 221, or larger than the resolution of the objective lens 213. Therefore the fluorescences 207a and 207b of the fluorescent biomolecules 202a and 202b are observable in arbitrary nano-apertures 205 of a plurality of nano-apertures 205, and hence alignment by a fluorescence detecting means is facilitated. Moreover, since the interval d between the nano-apertures 205 is the same as the resolution of the objective lens 213 of the fluorescence detecting means 221 or larger than the resolution of the objective lens 213, the fluorescences 207a and 207b of each fluorescent biomolecules 202a and 202b excited by each nano-aperture 205 can be separated, and the interaction between biomolecules can be detected at the level of a single molecule.

Furthermore, a method of analyzing a biomolecular interaction according to the foregoing embodiment comprises the steps of: generating the evanescent field 206 by the excitation light 203 from the nano-apertures 205 smaller than a wavelength λex of the excitation light 203; exciting the fluorescent biomolecules 202a and 202b which pass through a certain region of the evanescent field 206 by Brownian motion; and detecting the fluorescences 207a and 207b of the fluorescent biomolecules 202a and 202b. Hence, the fluorescent biomolecules 202a and 202b can be irradiated with the excitation light 203 in an area smaller than the wavelength λex of the excitation light 203, and the interaction between biomolecules can be detected at the level of a single molecule.

### Embodiment 12

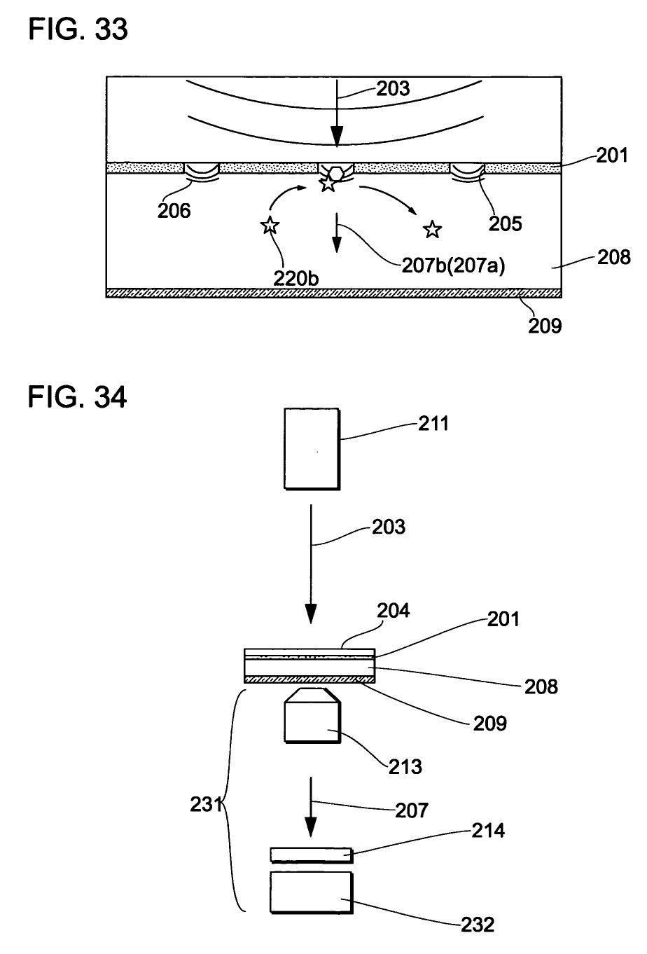

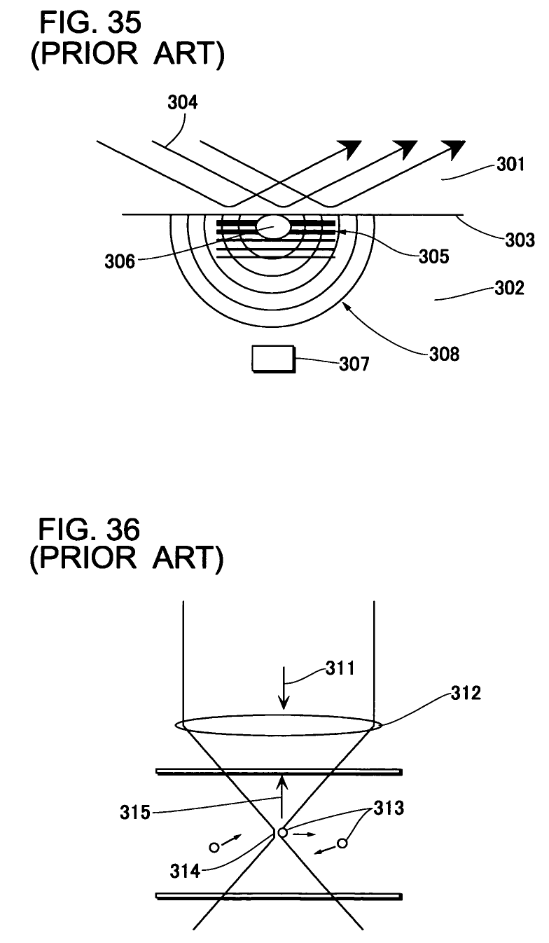

Next, a device for analyzing a biomolecular interaction according to a twelfth embodiment of the present invention will be explained with reference to FIG. 33 and FIG. 34. This device for analyzing a biomolecular interaction is equipment for detecting the biomolecular interaction of fluorescent biomolecules 202a and 202b from fluorescence 207b which the fluorescent biomolecule 202b emits, by using the fluorescent biomolecules 202a and 202b labeled with fluorescence molecules having different fluorescence wavelengths, by a single fluorescent molecule imaging method or multi fluorescent molecule micrometry, using the nano-aperture film 201. The same portions as those described in the above-mentioned embodiment are designated by the same reference numerals, and their detailed description is omitted.

Numeral 211 denotes a laser being an excitation light generating means for generating an excitation light. A lamp instead of the laser 211 may be used. This laser 211 is configured so that the nano-aperture film 201 is irradiated with the excitation light 203. The fluorescent biomolecule 202a is attached to the nano-aperture 205, and an aqueous solution 208 including the fluorescent biomolecule 220b is held between a side where the plate 204 is combined with the nano-aperture film 201, and a cover glass 209. The construction is such that the excitation light 203 irradiates from the side where the plate 204 is not combined with the nano-aperture film 201.

The outside of the cover glass 209 is provided with a fluorescence detecting means 231 for detecting the fluorescence 207 (207a, 207b) emitted from the fluorescent biomolecules 202a and 202b. This fluorescence detecting means 231 is provided with an objective lens 213 of a microscope (not shown), an optical filter 214, and a camera 232. The objective lens 213 is arranged so as to gather the fluorescence 207 (207a, 207b) emitted from the fluorescent biomolecules 202a and 202b. The optical filter 214 is arranged so as to remove background light, such as dispersion light and pass only the fluorescence 207 (207a, 207b). The resolution of the objective lens 213 is defined by the formula: 0.61 λem/NA for a numerical aperture (NA) of the objective lens 213 as above-mentioned. In addition, the image of the fluorescence 207 (207a, 207b) which has passed through the optical filter 214 is arranged so as to be detected by the high-sensitivity camera 232.

Next, an analysis method by using the above-mentioned device for analyzing a biomolecular interaction will be explained. Firstly, the aqueous solution 208 including the fluorescent biomolecule 202 is added between the nano-aperture film 201 and the cover glass 209, and the fluorescent biomolecule 202 is allowed to attach to the nano-aperture 205. The fluorescent biomolecule 202 unattached to the nano-aperture 205 is washed away, and then the aqueous solution 208 including another fluorescent biomolecule 202b is added between the nano-aperture film 201 and the cover glass 209, and mounted on a microscope. The excitation light 203 is incident from the back side of the nano-aperture 205, and generates the evanescent field 206.

Firstly, the fluorescent biomolecule 202a is excited, the image of the fluorescence 207a is observed with the camera 232, and the position of the fluorescent biomolecule 202a is confirmed. In the case of the single fluorescent molecule imaging method, the number of the attached fluorescent biomolecules 202a is adjusted so as to be one or less for each nano-aperture 205. In case of multi fluorescent molecule micrometry, it is possible to set the number of the attached fluorescent biomolecules 202a to any value of one or more for each nano-aperture 205.

Next, by exciting another fluorescent biomolecule 202b and capturing the image of the fluorescence 207b by the camera 232, the situation of interactions, such as association and dissociation between the fluorescent biomolecule 202a attached to the nano-aperture 205 and the another fluorescent biomolecule 202b can be observed. In the case of the single fluorescent molecule imaging method, the analysis can be performed for each nano-aperture 205. Moreover, by using the same device as the device used by the single fluorescent molecule imaging method, if the molecules for observing are increased, observation by multi fluorescent molecule micrometry can be performed. However, in the case of multi fluorescent molecule micrometry, the fluorescence 207b from two or more nano-apertures 205 is detected simultaneously. Therefore, in the case of multi fluorescent molecule micrometry, detectors, such as a photomultiplier tube, in addition to camera 232 may be used. By the above method, an association rate constant, a dissociation rate constant, a dissociation constant, or the like, for the biomolecular interaction can be obtained.

As explained above, a device for analyzing a biomolecular interaction according to the foregoing embodiment comprises: the laser 211 being the excitation light generating means for generating the excitation light 203; the nano-aperture film 201 which comprises a thin film which does not transmit light, and in which the nano-apertures 205 are formed, wherein a diameter Φ being a maximum opening width of the nano-aperture is smaller than the wavelength % ex of the excitation light 203; and the fluorescence detecting means 231 for detecting the fluorescence 207 (207a, 207b). When the nano-aperture film 201 with the nano-apertures 205, the diameter Φ of which is smaller than the wavelength λex of the excitation light 203, is irradiated with the excitation light 203 from the laser 211, the evanescent field 206 is generated in the nano-apertures 205. Therefore, by using the evanescent field 206, the fluorescent biomolecules 202a and 202b can be irradiated with the excitation light 203 in an area smaller than the wavelength λex of the excitation light 203, and the fluorescences 207a and 207b emitted from the fluorescent biomolecules 202a and 202b are able to be detected with the fluorescence detecting means 231. Moreover, by irradiating the fluorescent biomolecules 202a and 202b with the excitation light 203 in an area smaller than the wavelength λex of the excitation light 203, the concentration in the solution 208 including the fluorescent biomolecules 202a and 202b can be increased. Furthermore, the influence of the nonspecific absorption of the fluorescent biomolecules 202a and 202b in the surface of the plate 204 being a glass surface, can be prevented. Thus detection or determination of the biomolecular interaction can be performed reliably.

Moreover, a plurality of nano-apertures 205 are provided and arranged at equal intervals, and the interval d between the nano-apertures 205 is the same as the resolution of the objective lens 213 of the fluorescence detecting means 231, or larger than the resolution of the objective lens 213. Therefore the fluorescence 207 of the fluorescent biomolecules 202a and 202b is observable in arbitrary nano-apertures 205 of a plurality of nano-apertures 205, and hence alignment by a fluorescence detecting means is facilitated. Moreover, since the interval between the nano-apertures 205 is the same as the resolution of the objective lens 213 of the fluorescence detecting means 231 or larger than the resolution of the objective lens 213, the fluorescences 207a and 207b of each fluorescent biomolecule 202a and 202b respectively excited by each nano-aperture 205 can be separated, and the interaction between biomolecules can be detected at the level of a single molecule.

Furthermore, a method of analyzing a biomolecular interaction according to the foregoing embodiment comprises the steps of: generating an evanescent field 206 by the excitation light 203 from the nano-aperture 205 smaller than a wavelength λex of the excitation light 203; exciting a first fluorescent biomolecule 202a attached to the nano-aperture 205, and a second fluorescent biomolecule 202b which is in a certain region of the evanescent field 206 and interacts with the first fluorescent biomolecule 202a; and detecting the fluorescences 207a and 207b of these first and second fluorescent biomolecules 202a and 202b, respectively. Hence, the fluorescent biomolecules 202a and 202b can be irradiated with the excitation light 203 in an area smaller than the wavelength λex of the excitation light 203, and the interaction between biomolecules can be detected and determined at the level of a single molecule.

As explained in detail above, according to the foregoing embodiment, by skillfully combining known methods, such as generation of an evanescent field from at least one nano-aperture, single fluorescent molecule imaging method, FCS and FCCS, the invention enables solving of the conventional theoretical problems, so that it is possible to add a molecule having a concentration as high as 100 to 1000 times the conventional critical concentration into an aqueous solution. It is also possible to limit the influence of the nonspecific adsorption to a glass side or the like, to about 1/100 lower than before.

Moreover, the invention can determine biomolecular interaction at a high sensitivity at the level of a single molecule, and is applicable to a wide range of fields such as biology, medicine, and pharmacy. In particular, research of the interaction between proteins is important as post-genome research. However, according to the invention, it is also possible to detect biomolecular interaction at high-sensitivity, especially the interaction between proteins at the level of a single molecule and carry out performance analysis. Furthermore, according to the invention, it is possible to detect a weak interaction in which the binding constant is smaller than 10⁶ M which has previously been impossible. This invention is immediately applicable to DNA chips or protein chips, and should demonstrate a significant influence in the analysis of the interaction between proteins.

The present invention is not limited to the above-mentioned embodiments, and various modification and variations are possible within the scope of the present invention. Although the film with a plurality of nano-apertures as explained here is shown, for example, the film may be a film with one nano-aperture.

What is claimed is:

1. A micro-system comprising a stimulation applying means for applying stimulation to a liquid flowing in a liquid channel formed in a plate, the liquid flow being controlled by the stimulation from the stimulation applying means, wherein the stimulation applying means comprises a control means for electrically controlling an amount of stimulation applied to the liquid.

2. The micro-system according to claim 1, further comprising a stimulation detecting means for detecting the amount of stimulation, wherein said stimulation applying means is a heat source or a light source, and said stimulation applying means is controlled by said control means based on a signal from said stimulation detecting means.

3. The micro-system according to claim 2, wherein said heat source is a micro-heater.

4. The micro-system according to claim 2, wherein said stimulation detecting means is a heat sensor provided on said liquid channel.

5. The micro-system according to claim 4, wherein said heat sensor is a thermocouple.

6. The micro-system according to claim 4, wherein said heat sensor is a heat sensitive semiconductor or an infrared ray sensitive sensor.

7. The micro-system according to claim 2, wherein said light source is at least one light emitting element installed in said plate.

8. The micro-system according to claim 7, wherein said light emitting element is embedded in said plate.

9. The micro-system according to claim 7, wherein said light emitting element is arranged outside said plate.

10. The micro-system according to claim 9, further comprising an optical guiding path for guiding a light from said light emitting element, said optical guiding path being formed horizontally with a surface of said plate in which said liquid channel is formed.

11. The micro-system according to claim 7, further comprising a plurality of light emitting elements.

12. The micro-system according to claim 1, further comprising:
an energy imparting means for imparting energy to said liquid; and
a change detecting means for detecting a change in a substance which causes a change by energy from said energy imparting means, wherein said stimulation applying means is controlled by said control means based on a signal from said change detecting means.

13. The micro-system according to claim 12, further comprising an energy guiding path for guiding the energy from said energy imparting means, said energy guiding path being formed horizontally with a surface of said plate.

14. The micro-system according to claim 12, wherein said change detecting means is a fluorescence detecting element or a light receiving element.

15. The micro-system according to claim 14, wherein said fluorescence detecting element or said light receiving element is arranged horizontally with the surface of said plate.

16. The micro-system according to claim 14, wherein said fluorescence detecting element or said light receiving element is arranged above said liquid channel.

17. The micro-system according to claim 1, further comprising:
a stand for mounting said plate; and
a positioning means for deciding a position of said plate on said stand.

18. A matrix type variable liquid channel, comprising two or more stimulation sensitive members arranged on a plate in a pattern of a two dimensional matrix.

19. The matrix type variable liquid channel according to claim 18, wherein said stimulation sensitive members on said plate are arranged at certain intervals.

20. The matrix type variable liquid channel according to claim 19, wherein a size of each stimulation sensitive member ranges from 2 μm or more to 20 μm or less.

21. The matrix type variable liquid channel according to claim 19, wherein said stimulation sensitive members are arranged at intervals from 2 μm or more to 20 μm or less.

22. The matrix type variable liquid channel according to claim 19, wherein said stimulation sensitive members are formed by vapor deposition, sputtering, Chemical Vapor Deposition (CVD), plating, plasma polymerization, or screen-printing.

23. The matrix type variable liquid channel according to claim 18, wherein said stimulation sensitive member is stimulated by applying a voltage or irradiating a light thereto.

24. A matrix type variable liquid channel system comprising:
a matrix type variable liquid channel which comprises two or more stimulation sensitive members arranged on a plate in a pattern of a two dimensional matrix;
a detecting means for detecting a substance on said plate;
a stimulation applying means for applying stimulation to said stimulation sensitive members; and
a control means for controlling the stimulation applying means based on the signal from said detecting means.

25. The matrix type variable liquid channel system according to claim 24, wherein said stimulation sensitive members on said plate are arranged at certain intervals.

26. The matrix type variable liquid channel system according to claim 25, wherein a size of each stimulation sensitive member ranges from 2 μm or more to 20 μm or less.

27. The matrix type variable liquid channel system according to claim 25, wherein said stimulation sensitive members are arranged at intervals from 2 μm or more to 20 μm or less.

28. The matrix type variable liquid channel system according to claim 25, wherein said stimulation sensitive members are formed by vapor deposition, sputtering, Chemical Vapor Deposition (CVD), plating, plasma polymerization, or screen-printing.

29. The matrix type variable liquid channel system according to claim 24, wherein said stimulation sensitive member is stimulated by said stimulation applying means applying stimulation thereto, said stimulation being application of voltage or irradiation of light.

30. A nano-aperture film, comprising a thin film which does not transmit light and in which at least one nano-aperture is formed.

31. The nano-aperture film according to claim 30, wherein said thin film is combined with a transparent plate.

32. The nano-aperture film according to claim 30, wherein a plurality of nano-apertures are provided and arranged at substantially equal intervals.

33. The nano-aperture film according to claim 30, wherein a maximum opening width of said nano-aperture is 200 nm or less.

34. A device for analyzing a biomolecular interaction comprising:
an excitation light generating means for generating excitation light;
a nano-aperture film which comprises a thin film which does not transmit light and in which at least one nano-aperture is formed, wherein a maximum opening width of said nano-aperture is smaller than the wavelength of said excitation light; and
a fluorescence detecting means for detecting fluorescence.

35. The device for analyzing a biomolecular interaction according to claim 34, wherein a plurality of nano-apertures are provided and arranged at equal intervals, and the interval between said nano-apertures is the same as the resolution of said fluorescence detecting means or larger than the resolution of said fluorescence detecting means.

36. A method of analyzing a biomolecular interaction, the method comprising the steps of:
generating an evanescent field by an excitation light from a nano-aperture smaller than a wavelength of the excitation light;
exciting a fluorescent biomolecule which passes through a certain region of the evanescent field by Brownian motion; and
detecting fluorescence of the fluorescent biomolecule.

37. A method of analyzing a biomolecular interaction, the method comprising the steps of:
generating an evanescent field by an excitation light from a nano-aperture smaller than a wavelength of the excitation light;
exciting a first fluorescent biomolecule allowed to attach to the nano-aperture, and a second fluorescent biomolecule which is in a certain region of the evanescent field and interacts to said first fluorescent biomolecule; and
detecting fluorescence of these first and second fluorescent biomolecules, respectively.
